(19) United States
(12) Patent Application Publication
(10) Pub. No.: US 2022/0304040 A1
(43) Pub. Date: Sep. 22, 2022

(54) METHOD FOR TRANSMITTING AND RECEIVING SOUNDING REFERENCE SIGNAL, AND DEVICE THEREFOR

(71) Applicant: LG Electronics Inc., Seoul (KR)

(72) Inventors: Sechang MYUNG, Seoul (KR); Seonwook KIM, Seoul (KR); Suckchel YANG, Seoul (KR)

(21) Appl. No.: 17/638,404

(22) PCT Filed: Jul. 26, 2021
(86) PCT No.: PCT/KR2021/009614

§ 371 Date: Feb. 25, 2022

(30) Foreign Application Priority Data
Jul. 30, 2020 (KR) 10-2020-0095486

(51) Int. Cl. H04W 72/12; H04L 5/00

(52) U.S. Cl. CPC H04W 72/1289; H04L 5/0048; H04W 72/1268

(57) ABSTRACT

Disclosed is a method of transmitting a sounding reference signal (SRS) by a user equipment in a wireless communication system. The method includes receiving downlink control information (DCI) for scheduling an uplink channel and the SRS, obtaining a channel access parameter included in the DCI, and transmitting, based on the DCI scheduling the SRS without scheduling the uplink channel, the SRS based on the channel access parameter

### TECHNICAL FIELD

The present disclosure relates to a method of transmitting and receiving a sounding reference signal (SRS) and an apparatus therefor. More specifically, the present disclosure relates to a method of applying a channel access parameter including a channel access type (CAT)/cyclic prefix extension (CPE)/channel access priority class (CAPC) when the SRS is transmitted in an unlicensed band, and an apparatus therefor.

### BACKGROUND ART

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle-to-everything (V2X), emergency service, and remote control), and mMTC is a future-generation mobile communication scenario characterized by low cost, low energy, short packet, and massive connectivity (e.g., Internet of things (IoT)).

### DISCLOSURE

### Technical Problem

The present disclosure provides a method of transmitting and receiving an SRS and an apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description. Technical Solution

According to an aspect of the present disclosure, provided herein is a method of transmitting a sounding reference signal (SRS) by a user equipment (UE) in a wireless communication system, including receiving downlink control information (DCI) for scheduling an uplink channel and the SRS, obtaining a channel access parameter included in the DCI, and transmitting, based on the DCI scheduling the SRS without scheduling the uplink channel, the SRS based on the channel access parameter.

The uplink channel may be a physical uplink control channel (PUCCH) based on the DCI being downlink scheduling DCI.

The uplink channel may be a physical uplink shared channel (PUSCH) based on the DCI being uplink scheduling DCI.

The channel access parameter may be for informing information relate to at least one of a channel access type (CAT), cyclic prefix extension (CPE), or a channel access priority class (CAPC).

The DCI may include an invalid physical uplink control channel (PUCCH) transmission timing value.

The DCI may is for trigger a channel state information reference signal (CSI-RS).

In another aspect of the present disclosure, provided herein is a user equipment (UE) for transmitting a sounding reference signal (SRS) in a wireless communication system, including at least one transceiver; at least one processor; and at least memory operably connected to the at least one processor and configured to store instructions causing, when executed, the at least one processor to perform an operation. The operation includes receiving downlink control information (DCI) for scheduling an uplink channel and the SRS through the at least one transceiver, obtaining a channel access parameter included in the DCI, and transmitting, based on the DCI scheduling the SRS without scheduling the uplink channel, the SRS based on the channel access parameter through the at least one transceiver.

The uplink channel may be a physical uplink control channel (PUCCH) based on the DCI being downlink scheduling DCI.

The uplink channel may be a physical uplink shared channel (PUSCH) based on the DCI being uplink scheduling DCI.

The channel access parameter may be for informing information related to at least one of a channel access type (CAT), cyclic prefix extension (CPE), or a channel access priority class (CAPC).

The DCI may include an invalid physical uplink control channel (PUCCH) transmission timing value.

The DCI may is for trigger a channel state information reference signal (CSI-RS).

In another aspect of the present disclosure, provided herein is an apparatus for a user equipment (UE) for transmitting a sounding reference signal (SRS) in a wireless communication system, including at least one processor; and at least memory operably connected to the at least one processor and configured to store instructions causing, when executed, the at least one processor to perform an operation. The operation includes receiving downlink control information (DCI) for scheduling an uplink channel and the SRS, obtaining a channel access parameter included in the DCI, and transmitting, based on the DCI scheduling the SRS without scheduling the uplink channel, the SRS based on the channel access parameter.

In another aspect of the present disclosure, provided herein is a computer-readable storage medium including at least one computer program causing at least one processor to perform an operation. The operation includes receiving downlink control information (DCI) for scheduling an uplink channel and a sounding reference signal (SRS), obtaining a channel access parameter included in the DCI, and transmitting, based on the DCI scheduling the SRS without scheduling the uplink channel, the SRS based on the channel access parameter.

In another aspect of the present disclosure, provided herein is a method of receiving a sounding reference signal (SRS) by a base station (BS) in a wireless communication system, including transmitting downlink control information (DCI) for scheduling an uplink channel and the SRS, and receiving, based on the DCI scheduling the SRS without scheduling the uplink channel, the SRS based on a channel access parameter informed by the DCI.

In another aspect of the present disclosure, provided herein is a base station (BS) for receiving a sounding reference signal (SRS) in a wireless communication system, including at least one transceiver; at least one processor; and at least memory operably connected to the at least one processor and configured to store instructions causing, when executed, the at least one processor to perform an operation. The operation includes transmitting downlink control information (DCI) for scheduling an uplink channel and the SRS through the at least one transceiver, and receiving, based on the DCI scheduling the SRS without scheduling the uplink channel, the SRS based on a channel access parameter informed by the DCI through the at least one transceiver.

### Advantageous Effects

According to the present disclosure, uplink signals may be efficiently transmitted by flexibly applying a CAT, CPE, and a CAPC even to a physical uplink control channel (PUCCH) and an SRS in addition to a physical uplink shared channel (PUSCH).

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 illustrates physical channels and a general signal transmission method using the physical channels in a 3^{rd} generation partnership project (3GPP) system as an exemplary wireless communication system;

FIG. 2 illustrates a radio frame structure;

FIG. 3 illustrates a resource grid during the duration of a slot;

FIG. 4 illustrates exemplary mapping of physical channels in a slot;

FIG. 5 illustrates a physical uplink control channel (PUCCH) and physical uplink shared channel (PUSCH) transmission process;

FIG. 6 illustrates exemplary uplink (UL) transmission operations of a user equipment (UE);

FIG. 7 illustrates exemplary repeated transmissions based on a configured grant;

FIG. 8 illustrates a wireless communication system supporting an unlicensed band;

FIG. 9 illustrates an exemplary method of occupying resources in an unlicensed band;

FIG. 10 illustrates an exemplary channel access procedure of a UE for UL signal transmission and/or DL signal transmission in an unlicensed band applicable to the present disclosure;

FIG. 11 is a diagram for explaining a listen-before-talk subband (LBT-SB) applicable to the present disclosure;

FIG. 12 is a diagram for explaining a resource block (RB) interlace applicable to the present disclosure'

FIG. 13 is a diagram for explaining a resource assignment method for UL transmission in a shared spectrum applicable to the present disclosure;

FIGS. 14 and 15 are diagrams for explaining a sounding reference signal (SRS) applicable to the present disclosure;

FIGS. 16 to 18 are diagrams for explaining overall operation processes of a UE, a base station (BS), and a network according to an embodiment of the present disclosure;

FIG. 19 illustrates an exemplary communication system applied to the present disclosure;

FIG. 20 illustrates an exemplary wireless device applicable to the present disclosure; and

FIG. 21 illustrates an exemplary vehicle or autonomous driving vehicle applicable to the present disclosure.

### BEST MODE

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3^{rd} generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

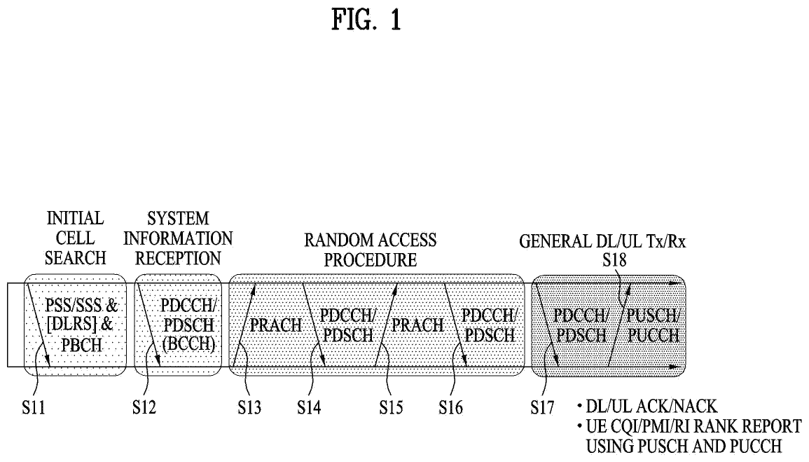

FIG. 1 illustrates physical channels and a general signal transmission method using the physical channels in a 3GPP system.

When a UE is powered on or enters a new cell, the UE performs initial cell search (S11). The initial cell search involves acquisition of synchronization to a BS. For this purpose, the UE receives a synchronization signal block (SSB) from the BS. The SSB includes a primary synchronization signal (PSS), a secondary synchronization signal (SSS), and a physical broadcast channel (PBCH). The UE synchronizes its timing to the BS and acquires information such as a cell identifier (ID) based on the PSS/SSS. Further, the UE may acquire information broadcast in the cell by receiving the PBCH from the BS. During the initial cell search, the UE may also monitor a DL channel state by receiving a downlink reference signal (DL RS).

After the initial cell search, the UE may acquire more detailed system information by receiving a physical downlink control channel (PDCCH) and a physical downlink shared channel (PDSCH) corresponding to the PDCCH (S12).

Subsequently, to complete connection to the BS, the UE may perform a random access procedure with the BS (S13 to S16). Specifically, the UE may transmit a preamble on a physical random access channel (PRACH) (S13) and may receive a PDCCH and a random access response (RAR) for the preamble on a PDSCH corresponding to the PDCCH (S14). The UE may then transmit a physical uplink shared channel (PUSCH) by using scheduling information in the RAR (S15), and perform a contention resolution procedure including reception of a PDCCH and a PDSCH signal corresponding to the PDCCH (S16).

When the random access procedure is performed in two steps, steps S13 and S15 may be performed as one step (in which Message A is transmitted by the UE), and steps S14 and S16 may be performed as one step (in which Message B is transmitted by the BS).

After the above procedure, the UE may receive a PDCCH and/or a PDSCH from the BS (S17) and transmit a physical uplink shared channel (PUSCH) and/or a physical uplink control channel (PUCCH) to the BS (S18), in a general UL/DL signal transmission procedure. Control information that the UE transmits to the BS is generically called uplink control information (UCI). The UCI includes a hybrid automatic repeat and request acknowledgement/negative acknowledgement (HARQ-ACK/NACK), a scheduling request (SR), channel state information (CSI), and so on. The CSI includes a channel quality indicator (CQI), a precoding matrix index (PMI), a rank indication (RI), and so on. In general, UCI is transmitted on a PUCCH. However, if control information and data should be transmitted simultaneously, the control information and the data may be transmitted on a PUSCH. In addition, the UE may transmit the UCI aperiodically on the PUSCH, upon receipt of a request/command from a network.

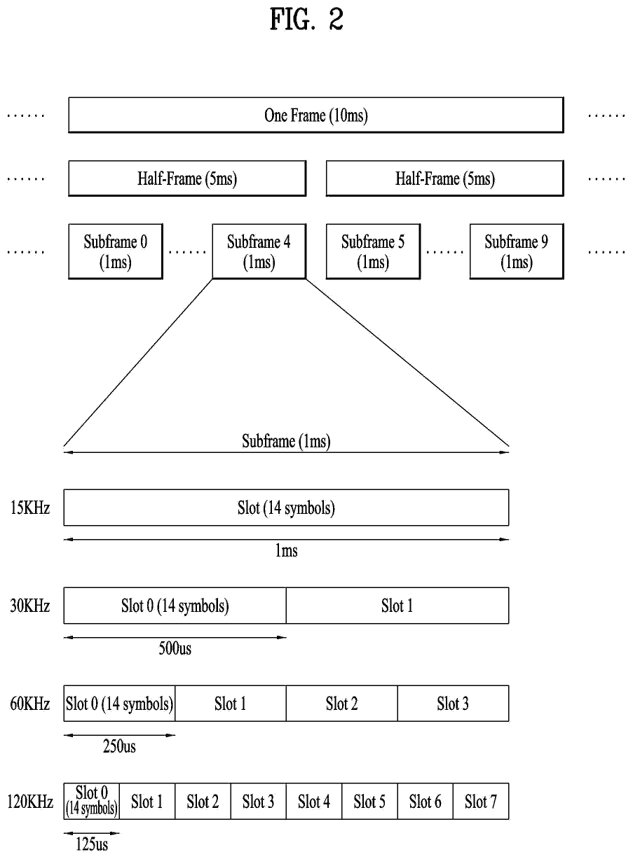

FIG. 2 illustrates a radio frame structure.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM(A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

N^{slot}_{symb}: number of symbols in a slot
N^{frame, u}ₛₗₒₜ: number of slots in a frame
N^{subframe, u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The frame structure is merely an example, and the number of subframes, the number of slots, and the number of symbols in a frame may be changed in various manners. In the NR system, different OFDM(A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding | |
|---|---|---|
| designation | frequency range | Subcarrier Spacing |
| FR1 | 450 MHz-7125 MHz | 15, 30, 60 kHz |
| FR2 | 24250 MHz-52600 MHz | 60, 120, 240 kHz |

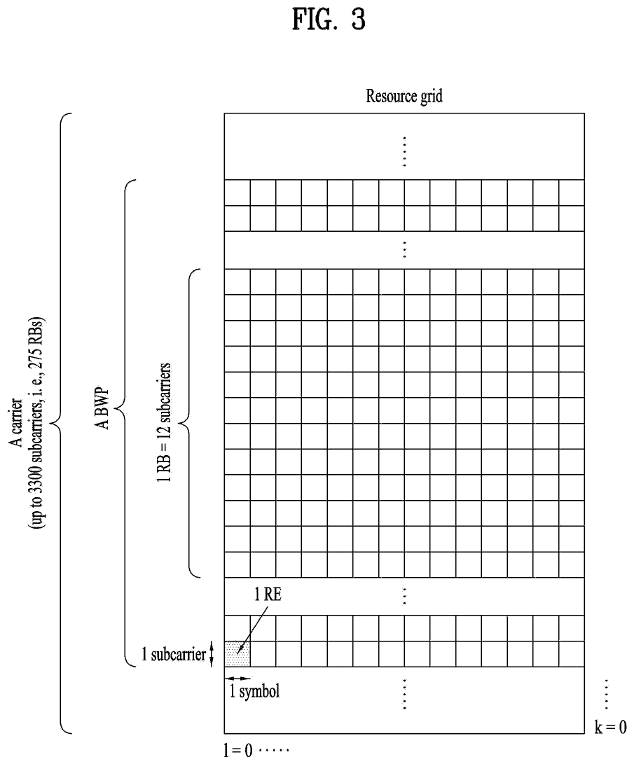

FIG. 3 illustrates a resource grid during the duration of one slot. A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A bandwidth part (BWP) may be defined by a plurality of consecutive (physical) RBs ((P)RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

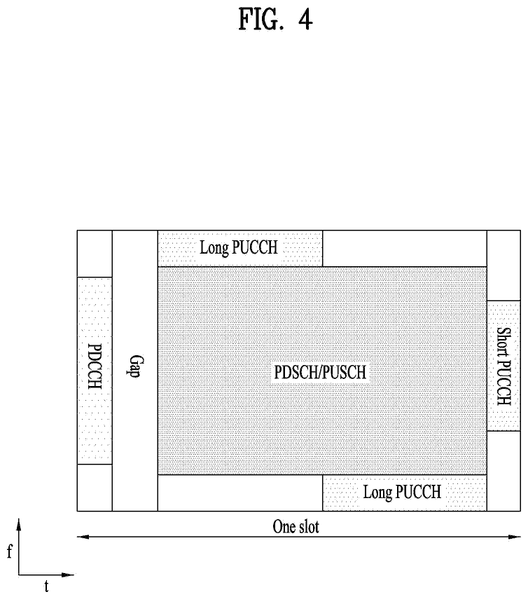

FIG. 4 illustrates exemplary mapping of physical channels in a slot.

A DL control channel, DL or UL data, and a UL control channel may all be included in one slot. For example, the first N symbols (hereinafter, referred to as a DL control region) in a slot may be used to transmit a DL control channel, and the last M symbols (hereinafter, referred to as a UL control region) in the slot may be used to transmit a UL control channel. N and M are integers equal to or greater than 0. A resource region (hereinafter, referred to as a data region) between the DL control region and the UL control region may be used for DL data transmission or UL data transmission. A time gap for DL-to-UL or UL-to-DL switching may be defined between a control region and the data region. A PDCCH may be transmitted in the DL control region, and a PDSCH may be transmitted in the DL data region. Some symbols at the time of switching from DL to UL in a slot may be configured as the time gap.

Now, a detailed description will be given of physical channels.

DL Channel Structures

An eNB transmits related signals on later-described DL channels to a UE, and the UE receives the related signals on the DL channels from the eNB.

(1) Physical Downlink Shared Channel (PDSCH)

The PDSCH carries DL data (e.g., a DL-shared channel transport block (DL-SCH TB)) and adopts a modulation scheme such as quadrature phase shift keying (QPSK), 16-ary quadrature amplitude modulation (16 QAM), 64-ary QAM (64 QAM), or 256-ary QAM (256 QAM). A TB is encoded to a codeword. The PDSCH may deliver up to two codewords. The codewords are individually subjected to scrambling and modulation mapping, and modulation symbols from each codeword are mapped to one or more layers. An OFDM signal is generated by mapping each layer together with a DMRS to resources, and transmitted through a corresponding antenna port.

(2) Physical Downlink Control Channel (PDCCH)

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g. a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

The PDCCH uses a fixed modulation scheme (e.g., QPSK). One PDCCH includes 1, 2, 4, 8, or 16 control channel elements (CCEs) according to its aggregation level (AL). One CCE includes 6 resource element groups (REGs), each REG being defined by one OFDM symbol by one (P)RB.

The PDCCH is transmitted in a control resource set (CORESET). The CORESET corresponds to a set of physical resources/parameters used to deliver the PDCCH/DCI in a BWP. For example, the CORESET is defined as a set of REGs with a given numerology (e.g., an SCS, a CP length, or the like). The CORESET may be configured by system information (e.g., a master information block (MIB)) or UE-specific higher-layer signaling (e.g., RRC signaling). For example, the following parameters/information may be used to configure a CORESET, and a plurality of CORESETs may overlap with each other in the time/frequency domain.

controlResourceSetId: indicates the ID of a CORESET.

frequencyDomainResources: indicates the frequency area resources of the CORESET. The frequency area resources are indicated by a bitmap, and each bit of the bitmap corresponds to an RB group (i.e., six consecutive RBs). For example, the most significant bit (MSB) of the bitmap corresponds to the first RB group of a BWP. An RB group corresponding to a bit set to 1 is allocated as frequency area resources of the CORESET.

duration: indicates the time area resources of the CORESET. It indicates the number of consecutive OFDMA symbols in the CORESET. For example, the duration is set to one of 1 to 3.

cce-REG-MappingType: indicates a CCE-to-REG mapping type. An interleaved type and a non-interleaved type are supported.

precoderGranularity: indicates a precoder granularity in the frequency domain.

tci-StatesPDCCH: provides information indicating a transmission configuration indication (TCI) state for the PDCCH (e.g., TCI-StateID). The TCI state is used to provide the quasi-co-location relation between DL RS(s) in an RS set (TCI-state) and PDCCH DMRS ports.

tci-PresentInDCI: indicates whether a TCI field is included in DCI.

pdcch-DMRS-ScramblingID: provides information used for initialization of a PDCCH DMRS scrambling sequence.

To receive the PDCCH, the UE may monitor (e.g., blind-decode) a set of PDCCH candidates in the CORESET. The PDCCH candidates are CCE(s) that the UE monitors for PDCCH reception/detection. The PDCCH monitoring may be performed in one or more CORESETs in an active DL BWP on each active cell configured with PDCCH monitoring. A set of PDCCH candidates monitored by the UE is defined as a PDCCH search space (SS) set. The SS set may be a common search space (CSS) set or a UE-specific search space (USS) set.

Table 4 lists exemplary PDCCH SSs.

TABLE 4

| | Search | | |
|---|---|---|---|
| Type | Space | RNTI | Use Case |
| Type0- | Common | SI-RNTI on a primary cell | SIB |
| PDCCH | | | Decoding |
| Type0A- | Common | SI-RNTI on a primary cell | SIB |
| PDCCH | | | Decoding |
| Type1- | Common | RA-RNTI or TC-RNTI on a | Msg2, Msg4 |
| PDCCH | | primary cell | decoding in |
| | | | RACH |
| Type2- | Common | P-RNTI on a primary cell | Paging |
| PDCCH | | | Decoding |
| Type3- | Common | INT-RNTI, SFI-RNTI, TPC- | |
| PDCCH | | PUSCH-RNTI, TPC-PUCCH- | |
| | | RNTI, TPC-SRS-RNTI, C- | |
| | | RNTI, MCS-C-RNTI,or CS- | |
| | | RNTI(s) | |
| UE | UE | C-RNTI, or MCS-C-RNTI, or | User specific |
| Specific | Specific | CS-RNTI(s) | PDSCH |
| | | | decoding |

The SS set may be configured by system information (e.g., MIB) or UE-specific higher-layer (e.g., RRC) signaling. S or fewer SS sets may be configured in each DL BWP of a serving cell. For example, the following parameters/information may be provided for each SS set. Each SS set may be associated with one CORESET, and each CORESET configuration may be associated with one or more SS sets.—searchSpaceId: indicates the ID of the SS set.

controlResourceSetId: indicates a CORESET associated with the SS set.

monitoringSlotPeriodicityAndOffset: indicates a PDCCH monitoring periodicity (in slots) and a PDCCH monitoring offset (in slots).

monitoringSymbolsWithinSlot: indicates the first OFDMA symbol(s) for PDCCH monitoring in a slot configured with PDCCH monitoring. The OFDMA symbols are indicated by a bitmap and each bit of the bitmap corresponds to one OFDM symbol in the slot. The MSB of the bitmap corresponds to the first OFDM symbol of the slot. OFDMA symbol(s) corresponding to bit(s) set to 1 corresponds to the first symbol(s) of the CORESET in the slot.

nrofCandidates: indicates the number of PDCCH candidates (e.g., one of 0, 1, 2, 3, 4, 5, 6, and 8) for each AL={1, 2, 4, 8, 16}.

searchSpaceType: indicates whether the SS type is CSS or USS.

DCI format: indicates the DCI format of PDCCH candidates.

The UE may monitor PDCCH candidates in one or more SS sets in a slot based on a CORESET/SS set configuration. An occasion (e.g., time/frequency resources) in which the PDCCH candidates should be monitored is defined as a PDCCH (monitoring) occasion. One or more PDCCH (monitoring) occasions may be configured in a slot.

Table 5 illustrates exemplary DCI formats transmitted on the PDCCH.

TABLE 5

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs. DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

UL Channel Structures

A UE transmits a related signal to the BS on a UL channel, which will be described later, and the BS receives the related signal from the UE through the UL channel to be described later.

(1) Physical Uplink Control Channel (PUCCH)

The PUCCH carries UCI, HARQ-ACK and/or scheduling request (SR), and is divided into a short PUCCH and a long PUCCH according to the PUCCH transmission length.

The UCI includes the following information.

SR: information used to request UL-SCH resources.

HARQ-ACK: a response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.

CSI: feedback information for a DL channel. Multiple input multiple output (MIMO)-related feedback information includes an RI and a PMI.

Table 6 illustrates exemplary PUCCH formats. PUCCH formats may be divided into short PUCCHs (Formats 0 and 2) and long PUCCHs (Formats 1, 3, and 4) based on PUCCH transmission durations.

TABLE 6

| | Length in | | | |
|---|---|---|---|---|
| | OFDM | | | |
| PUCCH | symbols | Number | | |
| format | N_{symb}^{PUCCH} | of bits | Usage | Etc |
| 0 | 1-2 | ≤2 | HARQ, SR | Sequence |
| | | | | selection |
| 1 | 4-14 | ≤2 | HARQ, [SR] | Sequence |
| | | | | modulation |
| 2 | 1-2 | >2 | HARQ, CSI, | CP-OFDM |
| | | | [SR] | |
| 3 | 4-14 | >2 | HARQ, CSI, | DFT-s-OFDM |
| | | | [SR] | (no UE |
| | | | | multiplexing) |
| 4 | 4-14 | >2 | HARQ, CSI, | DFT-s-OFDM |
| | | | [SR] | (Pre DFT OCC) |

PUCCH format 0 conveys UCI of up to 2 bits and is mapped in a sequence-based manner, for transmission. Specifically, the UE transmits specific UCI to the BS by transmitting one of a plurality of sequences on a PUCCH of PUCCH format 0. Only when the UE transmits a positive SR, the UE transmits the PUCCH of PUCCH format 0 in PUCCH resources for a corresponding SR configuration. PUCCH format 1 conveys UCI of up to 2 bits and modulation symbols of the UCI are spread with an orthogonal cover code (OCC) (which is configured differently whether frequency hopping is performed) in the time domain. The DMRS is transmitted in a symbol in which a modulation symbol is not transmitted (i.e., transmitted in time division multiplexing (TDM)).

PUCCH format 2 conveys UCI of more than 2 bits and modulation symbols of the DCI are transmitted in frequency division multiplexing (FDM) with the DMRS. The DMRS is located in symbols #1, #4, #7, and #10 of a given RB with a density of 1/3. A pseudo noise (PN) sequence is used for a DMRS sequence. For 2-symbol PUCCH format 2, frequency hopping may be activated.

PUCCH format 3 does not support UE multiplexing in the same PRBs, and conveys UCI of more than 2 bits. In other words, PUCCH resources of PUCCH format 3 do not include an OCC. Modulation symbols are transmitted in TDM with the DMRS.

PUCCH format 4 supports multiplexing of up to 4 UEs in the same PRBs, and conveys UCI of more than 2 bits. In other words, PUCCH resources of PUCCH format 3 include an OCC. Modulation symbols are transmitted in TDM with the DMRS.

(2) Physical Uplink Shared Channel (PUSCH)

The PUSCH carries UL data (e.g., UL-shared channel transport block (UL-SCH TB)) and/or UL control information (UCI), and is transmitted based a Cyclic Prefix-Orthogonal Frequency Division Multiplexing (CP-OFDM) waveform or a Discrete Fourier Transform-spread-Orthogonal Frequency Division Multiplexing (DFT-s-OFDM) waveform. When the PUSCH is transmitted based on the DFT-s-OFDM waveform, the UE transmits the PUSCH by applying transform precoding. For example, when transform precoding is not allowed (e.g., transform precoding is disabled), the UE may transmit the PUSCH based on the CP-OFDM waveform. When transform precoding is allowed (e.g., transform precoding is enabled), the UE may transmit the PUSCH based on the CP-OFDM waveform or the DFT-s-OFDM waveform. PUSCH transmission may be dynamically scheduled by the UL grant in the DCI or may be semi-statically scheduled based on higher layer (e.g., RRC) signaling (and/or Layer 1 (L1) signaling (e.g., PDCCH)) (configured grant). PUSCH transmission may be performed on a codebook basis or a non-codebook basis.

Table 7 illustrates exemplary DCI formats transmitted on the PDCCH.

TABLE 7

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UEs. DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

UL Channel Structures

A UE transmits a related signal to the BS on a UL channel, which will be described later, and the BS receives the related signal from the UE through the UL channel to be described later.

(1) Physical Uplink Control Channel (PUCCH)

The PUCCH carries UCI, HARQ-ACK and/or scheduling request (SR), and is divided into a short PUCCH and a long PUCCH according to the PUCCH transmission length.

The UCI includes the following information.

SR: information used to request UL-SCH resources.

HARQ-ACK: a response to a DL data packet (e.g., codeword) on the PDSCH. An HARQ-ACK indicates whether the DL data packet has been successfully received. In response to a single codeword, a 1-bit of HARQ-ACK may be transmitted. In response to two codewords, a 2-bit HARQ-ACK may be transmitted. The HARQ-ACK response includes positive ACK (simply, ACK), negative ACK (NACK), discontinuous transmission (DTX) or NACK/DTX. The term HARQ-ACK is interchangeably used with HARQ ACK/NACK and ACK/NACK.

CSI: feedback information for a DL channel. Multiple input multiple output (MIMO)-related feedback information includes an RI and a PMI.

Table 8 illustrates exemplary PUCCH formats. PUCCH formats may be divided into short PUCCHs (Formats 0 and 2) and long PUCCHs (Formats 1, 3, and 4) based on PUCCH transmission durations.

TABLE 8

| | Length in | | | |
|---|---|---|---|---|
| | OFDM | | | |
| PUCCH | symbols | Number | | |
| format | N_{symb}^{PUCCH} | of bits | Usage | Etc |
| 0 | 1-2 | ≤2 | HARQ, SR | Sequence |
| | | | | selection |
| 1 | 4-14 | ≤2 | HARQ, [SR] | Sequence |
| | | | | modulation |
| 2 | 1-2 | >2 | HARQ, CSI, | CP-OFDM |
| | | | [SR] | |
| 3 | 4-14 | >2 | HARQ, CSI, | DFT-s-OFDM |
| | | | [SR] | (no UE |
| | | | | multiplexing) |
| 4 | 4-14 | >2 | HARQ, CSI, | DFT-s-OFDM |
| | | | [SR] | (Pre DFT OCC) |

PUCCH format 0 conveys UCI of up to 2 bits and is mapped in a sequence-based manner, for transmission. Specifically, the UE transmits specific UCI to the BS by transmitting one of a plurality of sequences on a PUCCH of PUCCH format 0. Only when the UE transmits a positive SR, the UE transmits the PUCCH of PUCCH format 0 in PUCCH resources for a corresponding SR configuration. PUCCH format 1 conveys UCI of up to 2 bits and modulation symbols of the UCI are spread with an orthogonal cover code (OCC) (which is configured differently whether frequency hopping is performed) in the time domain. The DMRS is transmitted in a symbol in which a modulation symbol is not transmitted (i.e., transmitted in time division multiplexing (TDM)).

PUCCH format 2 conveys UCI of more than 2 bits and modulation symbols of the DCI are transmitted in frequency division multiplexing (FDM) with the DMRS. The DMRS is located in symbols #1, #4, #7, and #10 of a given RB with a density of 1/3. A pseudo noise (PN) sequence is used for a DMRS sequence. For 2-symbol PUCCH format 2, frequency hopping may be activated.

PUCCH format 3 does not support UE multiplexing in the same PRBs, and conveys UCI of more than 2 bits. In other words, PUCCH resources of PUCCH format 3 do not include an OCC. Modulation symbols are transmitted in TDM with the DMRS.

PUCCH format 4 supports multiplexing of up to 4 UEs in the same PRBs, and conveys UCI of more than 2 bits. In other words, PUCCH resources of PUCCH format 3 include an OCC. Modulation symbols are transmitted in TDM with the DMRS.

(2) Physical Uplink Shared Channel (PUSCH)

The PUSCH carries UL data (e.g., UL-shared channel transport block (UL-SCH TB)) and/or UL control information (UCI), and is transmitted based a Cyclic Prefix-Orthogonal Frequency Division Multiplexing (CP-OFDM) waveform or a Discrete Fourier Transform-spread-Orthogonal Frequency Division Multiplexing (DFT-s-OFDM) waveform. When the PUSCH is transmitted based on the DFT-s-OFDM waveform, the UE transmits the PUSCH by applying transform precoding. For example, when transform precoding is not allowed (e.g., transform precoding is disabled), the UE may transmit the PUSCH based on the CP-OFDM waveform. When transform precoding is allowed (e.g., transform precoding is enabled), the UE may transmit the PUSCH based on the CP-OFDM waveform or the DFT-s-OFDM waveform. PUSCH transmission may be dynamically scheduled by the UL grant in the DCI or may be semi-statically scheduled based on higher layer (e.g., RRC) signaling (and/or Layer 1 (L1) signaling (e.g., PDCCH)) (configured grant). PUSCH transmission may be performed on a codebook basis or a non-codebook basis.

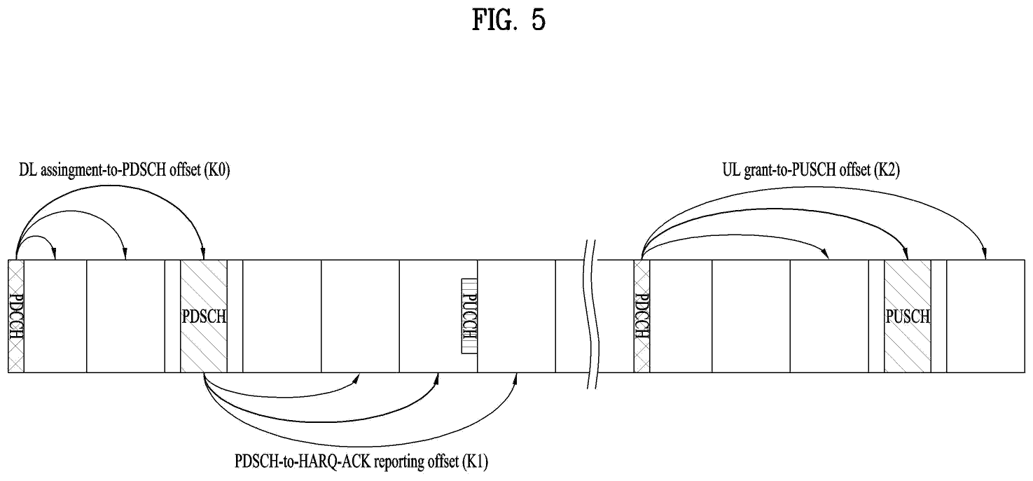

FIG. 5 is a diagram for explaining a HARQ transmission timing, a PUSCH transmission timing, and an assignment method.

HARQ-ACK is information indicating whether the UE has successfully received a physical DL channel. Upon successfully receiving the physical DL channel, the UE feeds back ACK to the BS and, otherwise, the UE feeds back NACK to the BS. In NR, HARQ supports 1-bit HARQ-ACK feedback per transport block. FIG. 5 illustrates an example of a HARQ-ACK timing K1.

In FIG. 5, K0 represents the number of slots from a slot with a PDCCH carrying DL assignment (i.e., DL grant) to a slot with corresponding PDSCH transmission, K1 represents the number of slots from a slot with a PDSCH to a slot with corresponding HARQ-ACK transmission, and K2 represents the number of slots from a slot with a PDCCH carrying a UL grant to a slot with corresponding PUSCH transmission. That is, K0, K1, and K2 may be briefly summarized as shown in Table 9 below.

TABLE 9

| | A | B |
|---|---|---|
| K0 | DL scheduling DCI | Corresponding DL data transmission |
| K1 | DL data reception | Corresponding HARQ-ACK |
| K2 | UL scheduling DCI | Corresponding UL data transmission |

The BS may provide a HARQ-ACK feedback timing to the UE dynamically by DCI or semi-statically by RRC signaling. The NR system supports different minimum HARQ processing times for UEs. A HARQ processing time includes delay between a DL data reception timing and a corresponding HARQ-ACK transmission timing and delay between a UL grant reception timing and a corresponding UL data transmission timing. The UE transmits information about the capability of a minimum HARQ processing time thereof to the BS. From the viewpoint of the UE, HARQ ACK/NACK feedback for a plurality of DL transmissions in the time domain may be transmitted in one UL data/control region. A timing between DL data reception and corresponding ACK is indicated by the DCI.

Unlike the LTE system in which a transport block (TB)-based or codeword-based HARQ procedure is performed, the NR system supports code block group (CBG)-based transmission of single-bit/multi-bit HARQ-ACK feedback. A TB may be mapped to one or more code blocks (CBs) according to the size of the TB. For example, in a channel coding procedure, a cyclic redundancy check (CRC) code is attached to the TB. If a CRC-attached TB is not larger than a certain size, the CRC-attached TB corresponds to one CB. However, if the CRC-attached TB is larger than the certain size, the CRC-attached TB is segmented into a plurality of CBs. In the NR system, the UE may be configured to receive CBG-based transmissions, and retransmission may be scheduled to carry a subset of all CBs of the TB.

Referring to FIG. 5, the UE may detect a PDCCH in slot #n. The PDCCH includes DL scheduling information (e.g., DCI format 1_0 and/or DCI format 1_1). The PDCCH indicates a DL assignment-to-PDSCH offset KO and a PDSCH-to-HARQ-ACK reporting offset K1. For example, DCI format 1_0 and DCI format 1_1 may include the following information.

Frequency domain resource assignment: indicates an RB resource assigned to a PDSCH (e.g. one or more (dis)continuous RBs).

Time domain resource assignment: indicates K0 and the starting position (e.g., OFDM symbol index) and length (e.g., the number of OFDM symbols) of a PDSCH in a slot.

PDSCH-to-HARQ feedback timing indicator: indicates K1.

HARQ process number (4 bits): indicates a HARQ process identity (ID) for data (e.g., a PDSCH or a TD).

PUCCH resource indicator (PRI): indicates a PUCCH resource to be used for UCI transmission among a plurality of PUCCH resources in a PUCCH resource set.

Next, the UE may receive a PDSCH in slot #(n+K0) according to scheduling information of slot #n and then transmit UCI on a PUCCH in slot #(n+K1). The UCI includes a HARQ-ACK response to the PDSCH. In the case in which the PDSCH is configured to carry a maximum of one TB, the HARQ-ACK response may be configured in one bit. In the case in which the PDSCH is configured to carry up to two TBs, the HARQ-ACK response may be configured in two bits if spatial bundling is not configured and in one bit if spatial bundling is configured. When slot #(n+K1) is designated as a HARQ-ACK transmission timing for a plurality of PDSCHs, UCI transmitted in slot #(n+K1) includes HARQ-ACK responses to the plurality of PDSCHs.

Referring to FIG. 5, the UE may detect a PDCCH in slot #n. The PDCCH includes UL scheduling information (e.g., DCI format 0_0 and/or DCI format 0_1). DCI format 0_0 and DCI format 0_1 may include the following information.

Frequency domain resource assignment: indicates an RB set assigned to a PUSCH.

Time domain resource assignment: indicates a slot offset K2 and the starting position (e.g., symbol index) and length (e.g., the number of OFDM symbols) of a PUSCH in a slot. The starting symbol and length may be indicated by a start and length indicator value (SLIV) or may be indicated individually.

Thereafter, the UE may transmit the PUSCH in slot #(n+k2) according to the scheduling information of slot #n. Here, the PUSCH includes a UL-SCH TB.

On DL, the BS may dynamically allocate resources for DL transmission to the UE by PDCCH(s) (including DCI format 1_0 or DCI format 1_1). Further, the BS may indicate to a specific UE that some of resources pre-scheduled for the UE have been pre-empted for signal transmission to another UE, by PDCCH(s) (including DCI format 2_1). Further, the BS may configure a DL assignment periodicity by higher-layer signaling and signal activation/deactivation of a configured DL assignment by a PDCCH in a semi-persistent scheduling (SPS) scheme, to provide a DL assignment for an initial HARQ transmission to the UE. When a retransmission for the initial HARQ transmission is required, the BS explicitly schedules retransmission resources through a PDCCH. When a DCI-based DL assignment collides with an SPS-based DL assignment, the UE may give priority to the DCI-based DL assignment.

Similarly to DL, for UL, the BS may dynamically allocate resources for UL transmission to the UE by PDCCH(s) (including DCI format 0_0 or DCI format 0_1). Further, the BS may allocate UL resources for initial HARQ transmission to the UE based on a configured grant (CG) method (similarly to SPS). Although dynamic scheduling involves a PDCCH for a PUSCH transmission, a configured grant does not involve a PDCCH for a PUSCH transmission. However, UL resources for retransmission are explicitly allocated by PDCCH(s). As such, an operation of preconfiguring UL resources without a dynamic grant (DG) (e.g., a UL grant through scheduling DCI) by the BS is referred to as a “CG”. Two types are defined for the CG.

Type 1: a UL grant with a predetermined periodicity is provided by higher-layer signaling (without L1 signaling).

Type 2: the periodicity of a UL grant is configured by higher-layer signaling, and activation/deactivation of the CG is signaled by a PDCCH, to provide the UL grant.

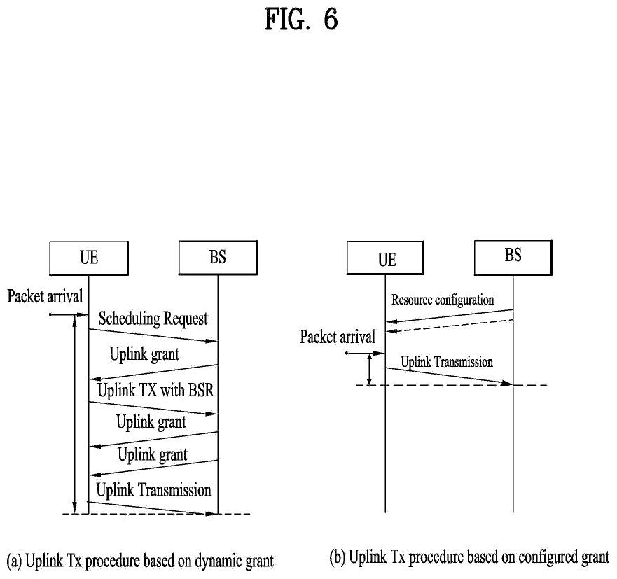

FIG. 6 illustrates exemplary UL transmission operations of a UE. The UE may transmit an intended packet based on a DG (FIG. 6(a)) or based on a CG (FIG. 6(b)).

Resources for CGs may be shared between a plurality of UEs. A UL signal transmission based on a CG from each UE may be identified by time/frequency resources and an RS parameter (e.g., a different cyclic shift or the like). Therefore, when a UE fails in transmitting a UL signal due to signal collision, the BS may identify the UE and explicitly transmit a retransmission grant for a corresponding TB to the UE.

K repeated transmissions including an initial transmission are supported for the same TB by a CG. The same HARQ process ID is determined for K times repeated UL signals based on resources for the initial transmission. The redundancy versions (RVs) of a K times repeated TB have one of the patterns {0, 2, 3, 1}, {0, 3, 0, 3}, and {0, 0, 0, 0}.

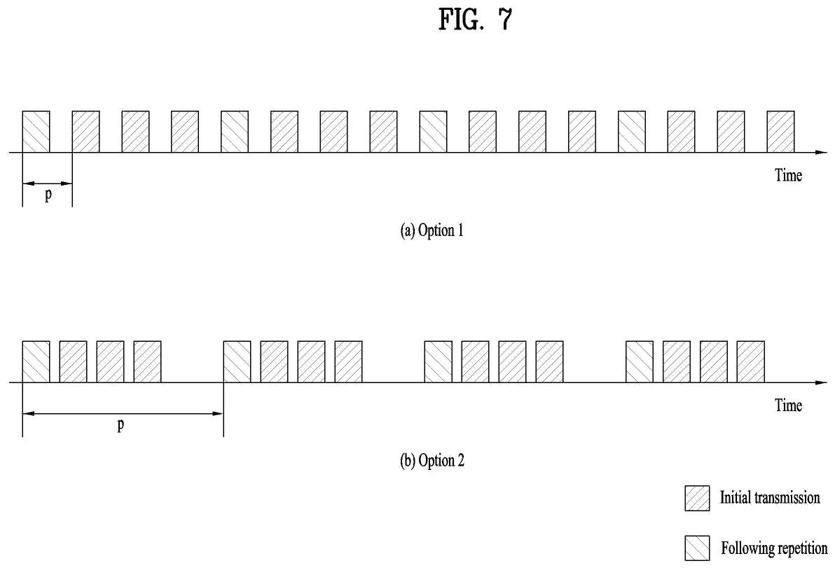

FIG. 7 illustrates exemplary repeated transmissions based on a CG.

The UE performs repeated transmissions until one of the following conditions is satisfied:

A UL grant for the same TB is successfully received;

The repetition number of the TB reaches K; and

(In Option 2) the ending time of a period P is reached.

Similarly to licensed-assisted access (LAA) in the legacy 3GPP LTE system, use of an unlicensed band for cellular communication is also under consideration in a 3GPP NR system. Unlike LAA, a stand-along (SA) operation is aimed in an NR cell of an unlicensed band (hereinafter, referred to as NR unlicensed cell (UCell)). For example, PUCCH, PUSCH, and PRACH transmissions may be supported in the NR UCell.

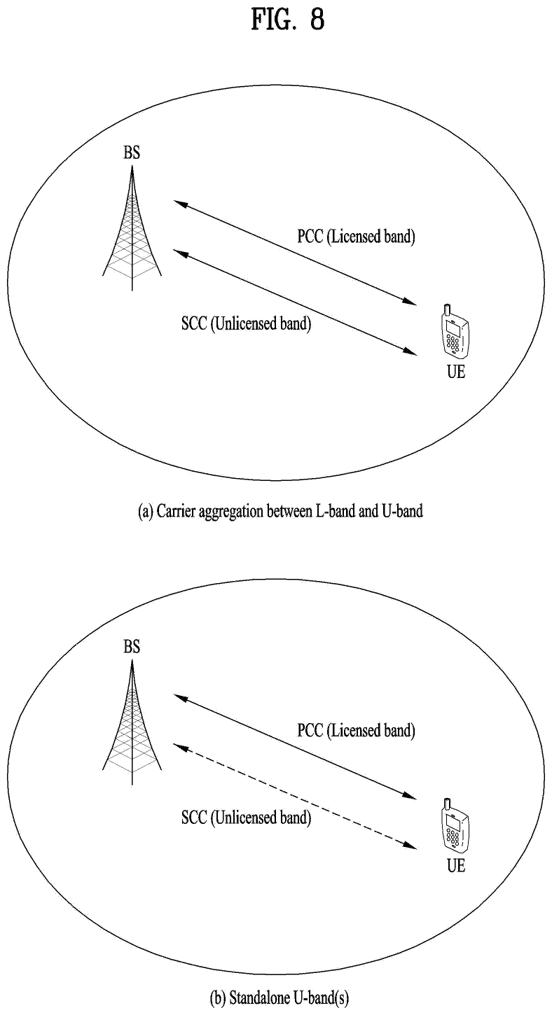

FIG. 8 illustrates an exemplary wireless communication system supporting an unlicensed band applicable to the present disclosure.

In the following description, a cell operating in a licensed band (L-band) is defined as an L-cell, and a carrier of the L-cell is defined as a (DL/UL) LCC. A cell operating in an unlicensed band (U-band) is defined as a U-cell, and a carrier of the U-cell is defined as a (DL/UL) UCC. The carrier/carrier-frequency of a cell may refer to the operating frequency (e.g., center frequency) of the cell. A cell/carrier (e.g., CC) is commonly called a cell.

When a BS and a UE transmit and receive signals on carrier-aggregated LCC and UCC as illustrated in FIG. 8(a), the LCC and the UCC may be configured as a primary CC (PCC) and a secondary CC (SCC), respectively. The BS and the UE may transmit and receive signals on one UCC or on a plurality of carrier-aggregated UCCs as illustrated in FIG. 8(b). In other words, the BS and UE may transmit and receive signals only on UCC(s) without using any LCC. For an SA operation, PRACH, PUCCH, PUSCH, and SRS transmissions may be supported on a UCell.

Signal transmission and reception operations in an unlicensed band as described in the present disclosure may be applied to the afore-mentioned deployment scenarios (unless specified otherwise).

Unless otherwise noted, the definitions below are applicable to the following terminologies used in the present disclosure.

Channel: a carrier or a part of a carrier composed of a contiguous set of RBs in which a channel access procedure (CAP) is performed in a shared spectrum.

Channel access procedure (CAP): a procedure of assessing channel availability based on sensing before signal transmission in order to determine whether other communication node(s) are using a channel. A basic sensing unit is a sensing slot with a duration of Tsl=9 μs. The BS or the UE senses the slot during a sensing slot duration. When power detected for at least 4 μs within the sensing slot duration is less than an energy detection threshold Xthresh, the sensing slot duration Tsl is be considered to be idle. Otherwise, the sensing slot duration Tsl is considered to be busy. CAP may also be called listen before talk (LBT).

Channel occupancy: transmission(s) on channel(s) from the BS/UE after a CAP.

Channel occupancy time (COT): a total time during which the BS/UE and any BS/UE(s) sharing channel occupancy performs transmission(s) on a channel after a CAP. Regarding COT determination, if a transmission gap is less than or equal to 25 μs, the gap duration may be counted in a COT. The COT may be shared for transmission between the BS and corresponding UE(s).

DL transmission burst: a set of transmissions without any gap greater than 16 μs from the BS. Transmissions from the BS, which are separated by a gap exceeding 16 μs are considered as separate DL transmission bursts. The BS may perform transmission(s) after a gap without sensing channel availability within a DL transmission burst.

UL transmission burst: a set of transmissions without any gap greater than 16 μs from the UE. Transmissions from the UE, which are separated by a gap exceeding 16 μs are considered as separate UL transmission bursts. The UE may perform transmission(s) after a gap without sensing channel availability within a DL transmission burst.

Discovery burst: a DL transmission burst including a set of signal(s) and/or channel(s) confined within a window and associated with a duty cycle. The discovery burst may include transmission(s) initiated by the BS, which includes a PSS, an SSS, and a cell-specific RS (CRS) and further includes a non-zero power CSI-RS. In the NR system, the discover burst includes may include transmission(s) initiated by the BS, which includes at least an SS/PBCH block and further includes a CORESET for a PDCCH scheduling a PDSCH carrying SIB1, the PDSCH carrying SIB1, and/or a non-zero power CSI-RS.

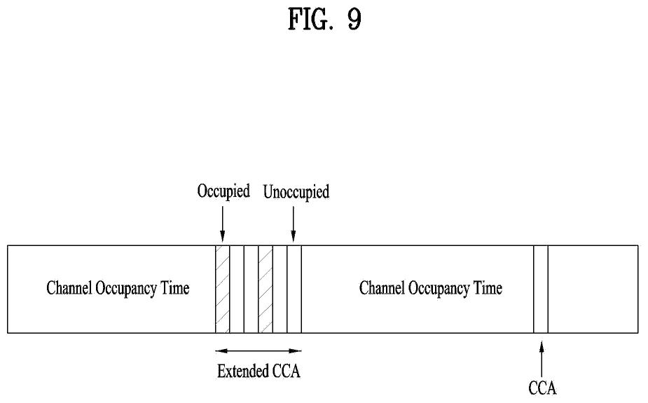

FIG. 9 illustrates an exemplary method of occupying resources in an unlicensed band.

Referring to FIG. 9, a communication node (e.g., a BS or a UE) operating in an unlicensed band should determine whether other communication node(s) is using a channel, before signal transmission. For this purpose, the communication node may perform a CAP to access channel(s) on which transmission(s) is to be performed in the unlicensed band. The CAP may be performed based on sensing. For example, the communication node may determine whether other communication node(s) is transmitting a signal on the channel(s) by carrier sensing (CS) before signal transmission. Determining that other communication node(s) is not transmitting a signal is defined as confirmation of clear channel assessment (CCA). In the presence of a CCA threshold (e.g., Xthresh) which has been predefined or configured by higher-layer (e.g., RRC) signaling, the communication node may determine that the channel is busy, when detecting energy higher than the CCA threshold in the channel. Otherwise, the communication node may determine that the channel is idle. When determining that the channel is idle, the communication node may start to transmit a signal in the unlicensed band. CAP may be replaced with LBT.

Table 9 describes an exemplary CAP supported in NR-U.

TABLE 9

| | Type | Explanation |
|---|---|---|
| DL | Type 1 CAP | CAP with random backoff |
| | | time duration spanned by the sensing slots that are |
| | | sensed to be idle before a downlink transmission(s) |
| | | is random |
| | Type 2 CAP | CAP without random backoff |
| | Type 2A, | time duration spanned by sensing slots that are sensed |
| | 2B, 2C | to be idle before a downlink transmission(s) is |
| | | deterministic |
| UL | Type 1 CAP | CAP with random backoff |
| | | time duration spanned by the sensing slots that are |
| | | sensed to be idle before a downlink transmission(s) |
| | | is random |
| | Type 2 CAP | CAP without random backoff |
| | Type 2A, | time duration spanned by sensing slots that are sensed |
| | 2B, 2C | to be idle before a downlink transmission(s) is |
| | | deterministic |

In a wireless communication system supporting an unlicensed band, one cell (or carrier (e.g., CC)) or BWP configured for a UE may be a wideband having a larger bandwidth (BW) than in legacy LTE. However, a BW requiring CCA based on an independent LBT operation may be limited according to regulations. Let a subband (SB) in which LBT is individually performed be defined as an LBT-SB. Then, a plurality of LBT-SBs may be included in one wideband cell/BWP. A set of RBs included in an LBT-SB may be configured by higher-layer (e.g., RRC) signaling. Accordingly, one or more LBT-SBs may be included in one cell/BWP based on (i) the BW of the cell/BWP and (ii) RB set allocation information. A plurality of LBT-SBs may be included in the BWP of a cell (or carrier). An LBT-SB may be, for example, a 20-MHz band. The LBT-SB may include a plurality of contiguous (P)RBs in the frequency domain, and thus may be referred to as a (P)RB set.

In Europe, two LBT operations are defined: frame based equipment (FBE) and load based equipment (LBE). In FBE, one fixed frame is made up of a channel occupancy time (e.g., 1 to 10 ms), which is a time period during which once a communication node succeeds in channel access, the communication node may continue transmission, and an idle period corresponding to at least 5% of the channel occupancy time, and CCA is defined as an operation of observing a channel during a CCA slot (at least 20 μs) at the end of the idle period. The communication node performs CCA periodically on a fixed frame basis. When the channel is unoccupied, the communication node transmits during the channel occupancy time, whereas when the channel is occupied, the communication node defers the transmission and waits until a CCA slot in the next period.

In LBE, the communication node may set q∈{4, 5, . . . , 32} and then perform CCA for one CCA slot. When the channel is unoccupied in the first CCA slot, the communication node may secure a time period of up to (13/32)q ms and transmit data in the time period. When the channel is occupied in the first CCA slot, the communication node randomly selects NE{1, 2, . . . , q}, stores the selected value as an initial value, and then senses a channel state on a CCA slot basis. Each time the channel is unoccupied in a CCA slot, the communication node decrements the stored counter value by 1. When the counter value reaches 0, the communication node may secure a time period of up to (13/32)q ms and transmit data.

An eNB/gNB or UE of the LTE/NR system should also perform LBT for signal transmission in an unlicensed band (referred to as a U-band for convenience). In addition, when the eNB or UE of the LTE/NR system transmits a signal, other communication nodes such as Wi-Fi should also perform LBT so that the eNB or the UE should not cause transmission interference. For example, in the Wi-Fi standard (801.11ac), a CCA threshold is defined as −62 dBm for a non-Wi-Fi signal and −82 dBm for a Wi-Fi signal. For example, when a signal other than the Wi-Fi signal is received by a station (STA) or an access point (AP) with a power of −62 dBm or more, the STA or AP does not transmit other signals in order not to cause interference.

A UE performs a Type 1 or Type 2 CAP for a UL signal transmission in an unlicensed band. In general, the UE may perform a CAP (e.g., Type 1 or Type 2) configured by a BS, for a UL signal transmission. For example, CAP type indication information may be included in a UL grant (e.g., DCI format 0_0 or DCI format 0_1) that schedules a PUSCH transmission.

In the Type 1 UL CAP, the length of a time period spanned by sensing slots sensed as idle before transmission(s) is random. The Type 1 UL CAP may be applied to the following transmissions.

PUSCH/SRS transmission(s) scheduled and/or configured by BS

PUCCH transmission(s) scheduled and/or configured by BS

Transmission(s) related to random access procedure (RAP)

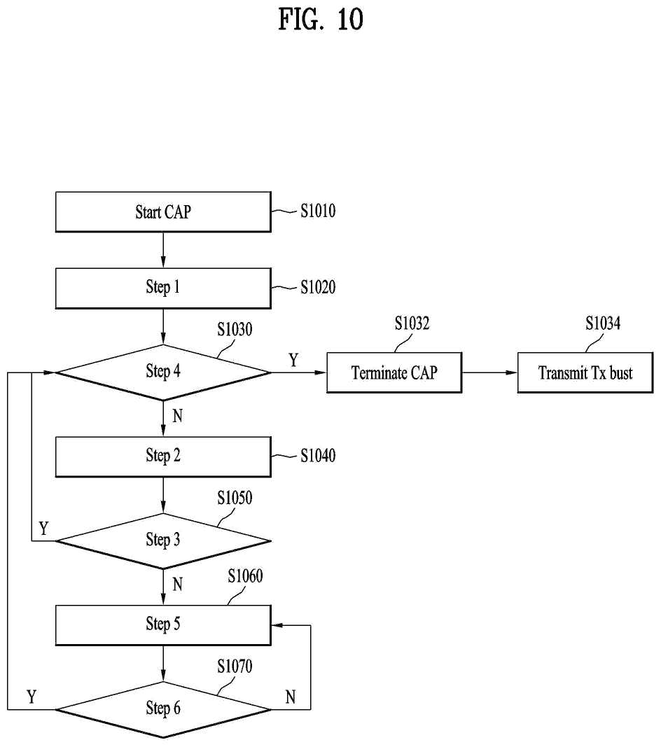

FIG. 10 illustrates a Type 1 CAP among CAPs of a UE for UL signal transmission and/or DL signal transmission in a U-band applicable to the present disclosure.

First, UL signal transmission in the U-band will be described with reference to FIG. 10.

The UE may sense whether a channel is idle for a sensing slot duration in a defer duration T_{d}. After a counter N is decremented to 0, the UE may perform a transmission (S1034). The counter N is adjusted by sensing the channel for additional slot duration(s) according to the following procedure.

Step 1) Set N=Nᵢₙᵢₜ where Nᵢₙᵢₜ is a random number uniformly distributed between 0 and CWₚ, and go to step 4 (S1020).

Step 2) If N>0 and the UE chooses to decrement the counter, set N=N−1 (S1040).

Step 3) Sense the channel for an additional slot duration, and if the additional slot duration is idle (Y), go to step 4. Else (N), go to step 5 (S1050).

Step 4) If N=0 (Y) (S1030), stop CAP (S1032). Else (N), go to step 2.

Step 5) Sense the channel until a busy sensing slot is detected within the additional defer duration T_{d} or all slots of the additional defer duration T_{d} are sensed as idle (S1060).

Step 6) If the channel is sensed as idle for all slot durations of the additional defer durationT_{d} (Y), go to step 4. Else (N), go to step 5 (S1070).

Table 10 illustrates that mp, a minimum CW, a maximum CW, a maximum channel occupancy time (MCOT), and an allowed CW size applied to a CAP vary according to channel access priority classes.

TABLE 10

| Channel | | | | | |
|---|---|---|---|---|---|
| Access | | | | | |
| Priority | | CWmin, | CWmax, | Tulmcot, | allowed CWp |
| Class (p) | mp | p | p | p | sizes |
| 1 | 2 | 3 | 7 | 2 ms | {3, 7} |
| 2 | 2 | 7 | 15 | 4 ms | {7, 15} |
| 3 | 3 | 15 | 1023 | 6 or | {15, 31, 63, 127, |
| | | | | 10 ms | 255, 511, 1023} |
| 4 | 7 | 15 | 1023 | 6 or | {15, 31, 63, 127, |
| | | | | 10 ms | 255, 511, 1023} |

The defer duration T_{d} includes a duration T_{f} (16 μs) immediately followed by mp consecutive slot durations where each slot duration Tₛₗ is 9 μs, and Tf includes a sensing slot duration Tₛₗ at the start of the 16-μs duration. CW_{min.p}<=CWₚ<=CW_{max.p}. CWₚ is set to CW_{min.p}, and may be updated before Step 1 based on an explicit/implicit reception response to a previous UL burst (e.g., PUSCH) (CW size update). For example, CWₚ may be initialized to CW_{min.p} based on an explicit/implicit reception response to the previous UL burst, may be increased to the next higher allowed value, or may be maintained to be an existing value.

In the Type 2 UL CAP, the length of a time period spanned by sensing slots sensed as idle before transmission(s) is deterministic. Type 2 UL CAPs are classified into Type 2A UL CAP, Type 2B UL CAP, and Type 2C UL CAP. In the Type 2A UL CAP, the UE may transmit a signal immediately after the channel is sensed as idle during at least a sensing duration T_{short_dl} (=25 μs). T_{short_dl} includes a duration Tf (=16 μs) and one immediately following sensing slot duration. In the Type 2A UL CAP, Tf includes a sensing slot at the start of the duration. In the Type 2B UL CAP, the UE may transmit a signal immediately after the channel is sensed as idle during a sensing slot duration T_{f} (=16 μs). In the Type 2B UL CAP, Tf includes a sensing slot within the last 9 μs of the duration. In the Type 2C UL CAP, the UE does not sense a channel before a transmission.

To allow the UE to transmit UL data in the unlicensed band, the BS should succeed in an LBT operation to transmit a UL grant in the unlicensed band, and the UE should also succeed in an LBT operation to transmit the UL data. That is, only when both of the BS and the UE succeed in their LBT operations, the UE may attempt the UL data transmission. Further, because a delay of at least 4 msec is involved between a UL grant and scheduled UL data in the LTE system, earlier access from another transmission node coexisting in the unlicensed band during the time period may defer the scheduled UL data transmission of the UE. In this context, a method of increasing the efficiency of UL data transmission in an unlicensed band is under discussion.

To support a UL transmission having a relatively high reliability and a relatively low time delay, NR also supports CG type 1 and CG type 2 in which the BS preconfigures time, frequency, and code resources for the UE by higher-layer signaling (e.g., RRC signaling) or both of higher-layer signaling and L1 signaling (e.g., DCI). Without receiving a UL grant from the BS, the UE may perform a UL transmission in resources configured with type 1 or type 2. In type 1, the periodicity of a CG, an offset from SFN=0, time/frequency resource allocation, a repetition number, a DMRS parameter, an MCS/TB size (TB S), a power control parameter, and so on are all configured only by higher-layer signaling such as RRC signaling, without L1 signaling. Type 2 is a scheme of configuring the periodicity of a CG and a power control parameter by higher-layer signaling such as RRC signaling and indicating information about the remaining resources (e.g., the offset of an initial transmission timing, time/frequency resource allocation, a DMRS parameter, and an MCS/TBS) by activation DCI as L1 signaling.

Now, DL signal transmission in the U-band will be described with reference to FIG. 10.

The BS may perform one of the following CAPs for DL signal transmission in the U-band.

(1) Type 1 DL CAP Method

In a Type 1 DL CAP, the length of a time duration spanned by sensing slots that are sensed to be idle before transmission(s) is random. The Type 1 DL CAP may be applied to the following transmissions.

Transmission(s) initiated by the BS, including (i) a unicast PDSCH with user plane data, or (ii) a unicast PDSCH with the user plane data and a unicast PDCCH scheduling the user plane data, or

Transmission(s) initiated by the BS, with (i) only a discovery burst, or (ii) a discovery burst multiplexed with non-unicast information.

Referring to FIG. 10, the BS may first sense whether a channel is in an idle state for a sensing slot duration of a defer duration Td. After a counter N is decremented to 0, transmission may be performed (S1034). The counter N is adjusted by sensing the channel for additional slot duration(s) according to the following procedures.

Step 1) Set N=Ninit where Ninit is a random number uniformly distributed between 0 and CWp, and go to step 4 (S1020).

Step 2) If N>0 and the BS chooses to decrement the counter, set N=N−1 (S1040).

Step 3) Sense the channel for an additional slot duration, and if the additional slot duration is idle (Y), go to step 4. Else (N), go to step 5 (S1050).

Step 4) If N=0 (Y), terminate a CAP (S1032). Else (N), go to Step 2 (S1030).

Step 5) Sense the channel until a busy sensing slot is detected within the additional defer duration Td or all slots of the additional defer duration Td are sensed to be idle (S1060).

Step 6) If the channel is sensed to be idle for all slot durations of the additional defer duration Td (Y), go to step 4. Else (N), go to step 5 (S1070).

Table 11 illustrates that mp, a minimum contention window (CW), a maximum CW, a maximum channel occupancy time (MCOT), and an allowed CW size, which are applied to a CAP vary according to channel access priority classes.

TABLE 11

| Channel | | | | | |
|---|---|---|---|---|---|
| Access | | | | | |
| Priority | | CWmin, | CWmax, | Tmcot, | allowed CWp |
| Class (p) | mₚ | p | p | p | sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

The defer duration Td includes a duration Tf (16 μs) immediately followed by mp consecutive sensing slot durations where each sensing slot duration Tsl is 9 μs, and Tf includes the sensing slot duration Tsl at the start of the 16-μs duration.

CWmin,p<=CWp<=CWmax,p. CWp is set to CWmin,p and may be updated (CW size update) before Step 1 based on HARQ-ACK feedback (e.g., ratio of ACK signals or NACK signals) for a previous DL burst (e.g., PDSCH). For example, CWp may be initialized to CWmin,p based on HARQ-ACK feedback for the previous DL burst, may be increased to the next highest allowed value, or may be maintained at an existing value.

(2) Type 2 DL CAP Method

In a Type 2 DL CAP, the length of a time duration spanned by sensing slots sensed to be idle before transmission(s) is deterministic. Type 2 DL CAPs are classified into Type 2A DL CAP, Type 2B DL CAP, and Type 2C DL CAP.

The Type 2A DL CAP may be applied to the following transmissions. In the Type 2A DL CAP, the BS may transmit a signal immediately after a channel is sensed to be idle during at least a sensing duration Tshort dl of 25 μs. Tshort dl includes a duration Tf (=16 μs) and one immediately following sensing slot duration. Tf includes a sensing slot at the start of the duration.

Transmission(s) initiated by the BS, with (i) only a discovery burst, or (ii) a discovery burst multiplexed with non-unicast information, or

Transmission(s) of the BS after a gap of 25 μs from transmission(s) by the UE within shared channel occupancy.

The Type 2B DL CAP is applicable to transmission(s) performed by the BS after a gap of 16 μs from transmission(s) by the UE within shared channel occupancy. In the Type 2B DL CAP, the BS may transmit a signal immediately after a channel is sensed to be idle during Tf=16 μs. Tf includes a sensing slot within the last 9 μs of the duration. The Type 2C DL CAP is applicable to transmission(s) performed by the BS after a maximum of a gap of 16 μs from transmission(s) by the UE within shared channel occupancy. In the Type 2C DL CAP, the BS does not sense a channel before performing transmission.

In a wireless communication system supporting a U-band, one cell (or carrier (e.g., CC)) or BWP configured for the UE may be a wideband having a larger bandwidth (BW) than in legacy LTE. However, a BW requiring CCA based on an independent LBT operation may be limited according to regulations. If a subband (SB) in which LBT is individually performed is defined as an LBT-SB, a plurality of LBT-SBs may be included in one wideband cell/BWP. A set of RBs included in an LBT-SB may be configured by higher-layer (e.g., RRC) signaling. Accordingly, one or more LBT-SBs may be included in one cell/BWP based on (i) the BW of the cell/BWP and (ii) RB set allocation information.

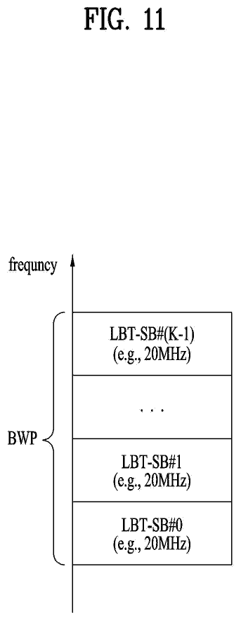

FIG. 11 illustrates that a plurality of LBT-SBs is included in a U-band.

Referring to FIG. 11, a plurality of LBT-SBs may be included in the BWP of a cell (or carrier). An LBT-SB may be, for example, a 20-MHz band. The LBT-SB may include a plurality of contiguous (P)RBs in the frequency domain and thus may be referred to as a (P)RB set. Although not illustrated, a guard band (GB) may be included between the LBT-SBs. Therefore, the BWP may be configured in the form of {LBT-SB #0 (RB set #0)+GB #0+LBT-SB #1 (RB set #1+GB #1)++LBT-SB #(K-1) (RB set (#K-1))}. For convenience, LBT-SB/RB indexes may be configured/defined to be increased as a frequency band becomes higher starting from a low frequency band.

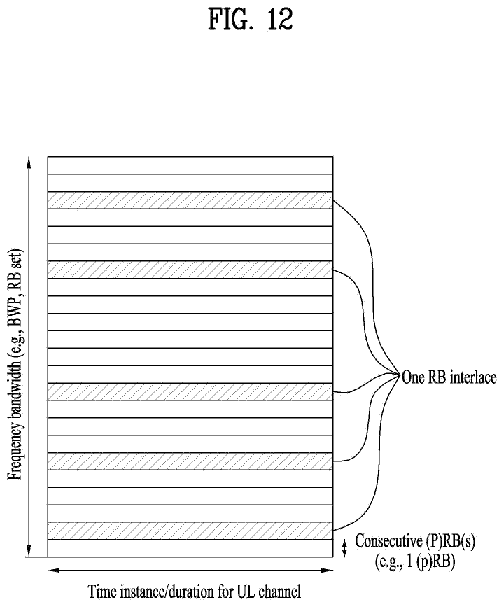

FIG. 12 illustrates an RB interlace. In a shared spectrum, a set of discontinuous RBs (at a regular interval) (or a single RB) in the frequency domain may be defined as a unit resource used/allocated to transmit a UL (physical) channel/signal in consideration of regulations on occupied channel bandwidth (OCB) and power spectral density (PSD). Such a set of discontinuous RBs is defined as an RB interlace (simply, interlace) for convenience.

Referring to FIG. 12, a plurality of RB interlaces (simply, interlaces) may be defined in a frequency bandwidth. Here, the frequency bandwidth may include a (wideband) cell/CC/BWP/RB set, and an RB may include a physical RB (PRB). For example, interlace #m∈{0, 1, . . . , M−1} may include (common) RBs {m, M+m, 2M+m, 3M+m, . . . }, where M denotes the number of interlaces. A transmitter (e.g., UE) may use one or more interlaces to transmit a signal/channel. The signal/channel may include a PUCCH or a PUSCH.

For example, in the case of UL resource assignment Type 2, RB assignment information (e.g., frequency domain resource assignment of FIG. E5) may indicate a maximum of M (positive integer) interlace indexes and N_{RB-set}^{BWP} consecutive RB sets (in the case of DCI 0_1) to the UE. Here, the RB set corresponds to frequency resources in which a CAP is individually performed in the shared spectrum and includes a plurality of consecutive (P)RBs. The UE may determine RB(s) corresponding to the intersection of the indicated interlaces and the indicated RB set(s) (and (if present) a GB between the indicated RB set(s)) as frequency resources for PUSCH transmission. Here, a GB between consecutive RB set(s) is also used as the frequency resources for PUSCH transmission. Therefore, RB(s) corresponding to the intersection of (1) the indicated interlaces and (2) (the indicated RB set(s)+(if present) the GB between the indicated RB set(s)) may be determined as the frequency resources for PUSCH transmission.

When u=0, X (positive integer) MSBs of the RB assignment information indicate an interlace index set (m0+1) assigned to the UE, and indication information consists of a resource indication value (MV). When 0<=MV<M(M+1)/2, then 1=0, 1 , . . . , L−1, and the MV corresponds to (i) a starting interlace index mo and (ii) the number L (positive integer) of consecutive interlace indexes. The RIV is defined as follows.

if (L−1)≤└M/2┘ then

RIV=M(L−1)+m₀ [Equation 1]

else

RIV=M(M−L+1)+(M−1−m₀)

where M denotes the number of interlaces, mo denotes a staring interlace index, L denotes the number of consecutive interlaces, and └ ┘ denotes a flooring function.

When RIV>=M(M+1)/2, the RIV corresponds to (i) the starting interlace index mo and (ii) a set of 1 values, as shown in Table E1.

TABLE 12

| RIV − M(M + 1)/2 | m₀ | 1 |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

When u=1, X (positive integer) MSBs of the RB assignment information (i.e., frequency domain resource assignment) includes a bitmap indicating interlaces allocated to the UE. The size of the bitmap is M bits, and each bit corresponds to an individual interlace. For example, interlaces #0 to #(M−1) are mapped in one-to-one correspondence to an MSB to an LSB of the bitmap, respectively. When a bit value in the bitmap is 1, a corresponding interlace is allocated to the UE, otherwise, the corresponding interlace is not allocated to the UE. When u=0 and u=1,

$$Y = ⌈ log 2 \frac{{N}_{R B - s e t}^{BWP} ( {N}_{R B - s e t}^{BWP} + 1 )}{2} ⌉$$

LSBs of the RB assignment information may indicate RB set(s) which are consecutively allocated for a PUSCH to the UE, where N^{BWP}_{RB-set} denotes the number of RB sets configured in a BWP, and ┌ ┐ denotes a ceiling function. The PUSCH may be scheduled by DCI format 0_1, a Type 1 configured grant, and a Type 2 configured grant. The resource assignment information may consist of the MV (hereinafter, RIV_{RBset}). When 0<=RIV_{RBset}<N^{BWP}_{RB-set}(N^{BWP}_{RB-set}+1)/2, then l=0, 1, . . . , L_{RBset-1}, and the RIV corresponds to (i) a starting RB set (RB_{setSTART}) and (ii) the number L_{RBset} (positive integer) of consecutive RB set(s). The RIV is defined as follows.

if (L_{RBset}−1)≤└N_{RB-set}^{BWP}/2┘ then

RIV_{RBset}=N_{RB-set}^{BWP}(L_{RBset}−1)+RBset_{START}

else

RIV_{RBset}=N_{RB-set}^{BWP}(N_{RB-set}^{BWP}−L_{RBset}+1)+(N_{RB-set}^{BWP}−1−RBset_{START}) [Equation 2]

where L_{RBset} denotes the number of consecutive RB set(s), N^{BWP}_{RB-set} denotes the number of RB sets configured in a BWP, RB_{setSTART} denotes an index of a staring RB set, and └ ┘ denotes a flooring function.

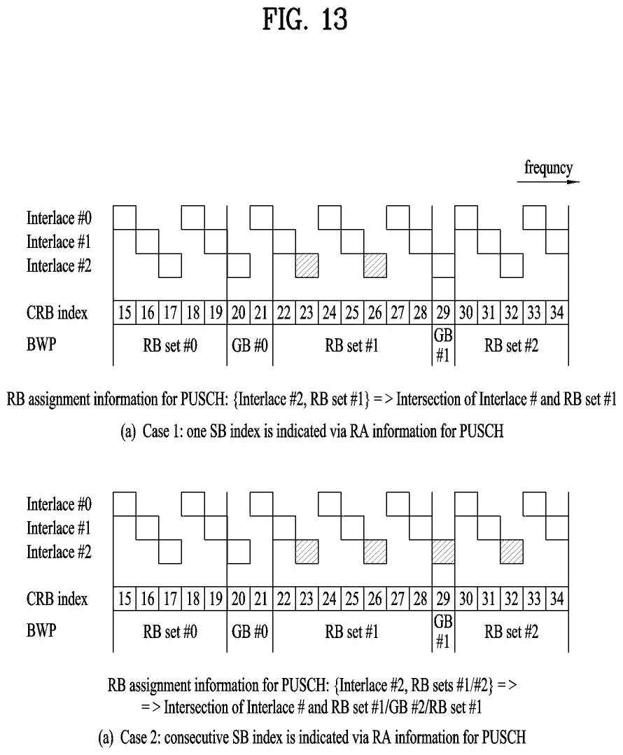

FIG. 13 illustrates resource assignment for UL transmission in a shared spectrum.

Referring to FIG. 13(a), RBs belonging to interlace #1 in RB set #1 may be determined as PUSCH resources based on resource assignment information for a PUSCH indicating {interlace #1, RB set #1}. That is, RBs corresponding to the intersection of {interlace #1, RB set #1} may be determined as the PUSCH resources. Referring to FIG. 13(b), RBs belonging to interlace #2 in RB sets #1 and #2 may be determined as the PUSCH resources based on resource assignment information for the PUSCH indicating {interlace #2, RB sets #1 and #2}. In this case, a GB (i.e., GB #1) between RB set #1 and RB set #2 may also be used as the PUSCH transmission resources. That is, RBs corresponding to the intersection of {interlace #1, RB sets #1 and #2, GB #1} may be determined as the PUSCH resources. In this case, a GB (i.e., GB #0) which is not between RB set #1 and RB set #2 is not used as the PUSCH transmission resources even if the GB is adjacent to RB sets #1 and #2.

Beam Management (BM)

The BM refers to a series of processes for acquiring and maintaining a set of BS beams (transmission and reception point (TRP) beams) and/or a set of UE beams available for DL and UL transmission/reception. The BM may include the following processes and terminology.

Beam measurement: an operation by which the BS or UE measures the characteristics of a received beamformed signal

Beam determination: an operation by which the BS or UE selects its Tx/Rx beams

Beam sweeping: an operation of covering a spatial domain by using Tx and/or Rx beams for a prescribed time interval according to a predetermined method

Beam report: an operation by which the UE reports information about a signal beamformed based on the beam measurement.

UL BM Process

In UL BM, beam reciprocity (or beam correspondence) between Tx and Rx beams may or may not be established according to the implementation of the UE. If the Tx-Rx beam reciprocity is established at both the BS and UE, a UL beam pair may be obtained from a DL beam pair. However, if the Tx-Rx beam reciprocity is established at neither the BS nor UE, a process for determining a UL beam may be required separately from determination of a DL beam pair.

In addition, even when both the BS and UE maintain the beam correspondence, the BS may apply the UL BM process to determine a DL Tx beam without requesting the UE to report its preferred beam.

The UL BM may be performed based on beamformed UL SRS transmission. Whether the UL BM is performed on a set of SRS resources may be determined by a usage parameter (RRC parameter). If the usage is determined as BM, only one SRS resource may be transmitted for each of a plurality of SRS resource sets at a given time instant.

The UE may be configured with one or more SRS resource sets (through RRC signaling), where the one or more SRS resource sets are configured by SRS-ResourceSet (RRC parameter). For each SRS resource set, the UE may be configured with K≥1 SRS resources, where K is a natural number, and the maximum value of K is indicated by SRS_capability.

The UL BM process may also be divided into Tx beam sweeping at the UE and Rx beam sweeping at the BS similarly to DL BM.

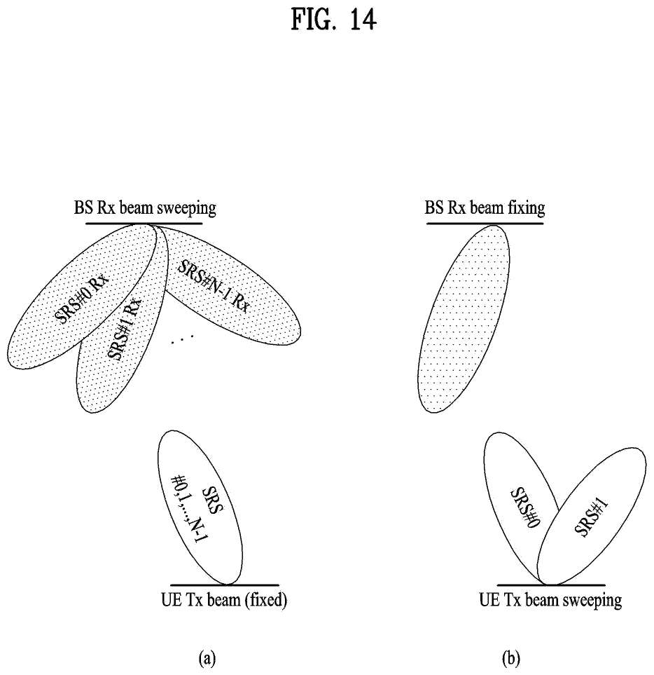

FIG. 14 illustrates an example of a UL BM process based on an SRS.

FIG. 14(a) shows a process in which the BS determines Rx beamforming, and FIG. 14(b) shows a process in which the UE performs Tx beam sweeping.

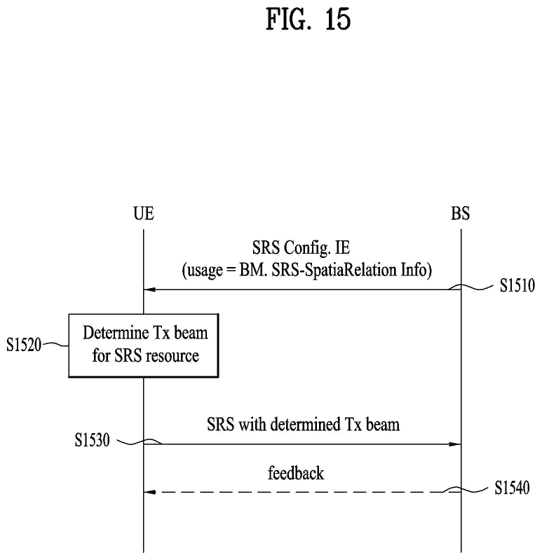

FIG. 15 is a flowchart illustrating an example of a UL BM process based on an SRS.

The UE receives RRC signaling (e.g., SRS-Config IE) including a usage parameter (RRC parameter) set to BM from the BS (S1510). The SRS-Config IE is used to configure SRS transmission. The SRS-Config IE includes a list of SRS resources and a list of SRS resource sets. Each SRS resource set refers to a set of SRS resources.

The UE determines Tx beamforming for SRS resources to be transmitted based on SRS-SpatialRelation Info included in the SRS-Config IE (S1520). Here, the SRS-SpatialRelation Info is configured for each SRS resource and indicates whether the same beamforming as that used for an SSB, a CSI-RS, or an SRS is applied for each SRS resource.

If SRS-SpatialRelationInfo is configured for the SRS resources, the same beamforming as that used in the SSB, CSI-RS, or SRS is applied and transmitted. However, if SRS-SpatialRelationInfo is not configured for the SRS resources, the UE randomly determines the Tx beamforming and transmits an SRS based on the determined Tx beamforming (S1530).

For a P-SRS in which ‘SRS-ResourceConfigType’ is set to ‘periodic’:

i) If SRS-SpatialRelationInfo is set to ‘SSB/PBCH’, the UE transmits the corresponding SRS by applying the same spatial domain transmission filter as a spatial domain reception filter used for receiving the SSB/PBCH (or a spatial domain transmission filter generated from the spatial domain reception filter);

ii) If SRS-SpatialRelationInfo is set to ‘CSI-RS’, the UE transmits the SRS by applying the same spatial domain transmission filter as that used for receiving the CSI-RS; or

iii) If SRS-SpatialRelationInfo is set to ‘SRS’, the UE transmits the corresponding SRS by applying the same spatial domain transmission filter as that used for transmitting the SRS.

Additionally, the UE may or may not receive feedback on the SRS from the BS as in the following three cases (S1540).

i) When SpatialRelationInfo is configured for all SRS resources in an SRS resource set, the UE transmits the SRS on a beam indicated by the BS. For example, if SpatialRelationInfo indicates the same SSB, CRI, or SRI, the UE repeatedly transmits the SRS on the same beam.

ii) SpatialRelationInfo may not be configured for all SRS resources in the SRS resource set. In this case, the UE may transmit while changing the SRS beamforming randomly.

iii) Spatial RelationInfo may be configured only for some SRS resources in the SRS resource set. In this case, the UE may transmit the SRS on an indicated beam for the configured SRS resources, but for SRS resources in which SpatialRelationInfo is not configured, the UE may perform transmission by applying random Tx beamforming

Sounding Reference Signal (SRS) Power Control

The UE may distribute the same power to antenna ports configured for SRS transmission. If the UE transmits an SRS on active UL BWP b of carrier f of serving cell c using SRS power control adjustment state index 1, SRS transmission power in SRS transmission occasion i may be determined as shown in Equation 3.

$${P}_{SRS , b , f , c} ( i , {q}_{s} , l ) = min \{ \begin{matrix}{P}_{CMAX , f , c} ( i ) , \\ {P}_{O \_ SRS , b , f , c} ( {q}_{s} ) + 10 {log}_{10} ( {2}^{μ} \cdot {M}_{SRS , b , f , c} ( i ) ) + {α}_{S R S , b , f , c} ( {q}_{s} ) \cdot {PL}_{b , f , c} ( {q}_{d} ) + {h}_{b , f , c} ( i , l )\end{matrix} \} [ dBm ] \qquad [ Equation 3 ]$$

In Equation 3, P_{CMAX,f,c}(i) denotes the maximum power output by the UE for carrier f of serving cell c in SRS transmission occasion i, and P_{O_SRS,b,f,c} (qₛ) may be obtained based on SRS resource set qₛ and p₀ for active UL BWP b.

In addition, M_{SRS,b,f,c}(i) is an SRS bandwidth expressed in the number of RBs for SRS transmission occasion i on active UL BWP b, and α_{SRS,b,f,c}(qₛ) may be obtained from alpha for UL BWP b of carrier f of serving cell c and SRS resource set qₛ. PL_{b,f,c}(q_{d}) is a DL pathloss estimate in dB and may be calculated based on RS index q_{d} for an active DL BWP of the serving cell and SRS resource set qₛ. The RS index q_{d} is provided by the higher layer parameter pathlossReferenceRS associated with SRS resource set qₛ. The UE may obtain an SS/PBCH block index or a CSI-RS resource index from pathlossReferenceRS. If the UE does not receive pathlossReferenceRSs, the UE may obtain PL_{b,f,c}(q_{d}) by using as a RS resource the SS/PBCH block index obtained from a master information block (MIB).

Additionally, h_{b,f,c}(i) may be defined by

$${h}_{b , f , c} ( i ) = {h}_{b , f , c} ( i - {i}_{0} ) + {\sum }_{m = 0}^{C ( {S}_{l} ) - 1} {δ}_{SRS , b , f , c} ( m ) ,$$

where the value of δ_{SRS,b,f,c} may be determined according to a predetermined table. In addition, δ_{SRS,b,f,c}(m) may be jointly coded with other transmit power control (TPC) commands included in DCI format 2_3, and

$${\sum }_{m = 0}^{C ( {S}_{l} ) - 1} {δ}_{SRS , b , f , c} ( m )$$

may be determined based on the sum of TPC command values included in a specific TPC command set.

In LTE licensed assisted access (LAA), for PUSCH transmission of the UE, one of LBT Types 1 and 2 may be indicated using a 1-bit field in a UL grant that schedules the corresponding PUSCH, and one of four PUSCH starting position candidates may be indicated using a 2-bit field. The UE may perform LBT based on an indicated LBT type and, upon succeeding in performing LBT, the UE may fill a portion immediately prior to the indicated PUSCH starting position through cyclic prefix extension (CPE) to perform transmission.

However, in the case of an SRS, the SRS has been transmitted without CPE under the assumption that the SRS always has the lowest channel priority class. That is, an LBT type and CPE for SRS transmission have not been indicated in LAA. Therefore, SRS transmission has always been performed without CPE. In addition, the value of a channel access priority class (CAPC) for SRS transmission has always been 1, and the SRS has been capable of being transmitted by basically performing LBT of LBT Type 1. Exceptionally, when it is confirmed that an SRS transmission timing is within a channel occupancy time (COT) through a group common (CG)-PDCCH, the SRS has been capable of being transmitted by performing LBT of LBT Type 2. However, even in this case, the SRS has been transmitted without application of CPE. In addition, a PUCCH has been transmitted only in a licensed band.

In LTE LAA, two LBT types (i.e., LBT Type 1 and LBT Type 2) have been used, whereas in NR-U, four LBT types (i.e., LBT Type 1, LBT Type 2A, LBT Type 2B, and LBT Type 2C) have been used. Therefore, for efficiency of SRS transmission, it is necessary to flexibly use the four LBT types even for SRS transmission based on a channel state at an SRS transmission timing. Here, the LBT types may mean the CAP types in [Table 9]. That is, LBT Type 1 may mean Type 1 CAP, and LBT Type 2A, LBT Type 2B, and LBT Type 2C may mean Type 2A CAP, Type 2B CAP, and Type 2C CAP, respectively, in [Table 9]. In addition, LBT Type 2 may mean Type 2 CAP.

In addition, LTE LAA has used only a single subcarrier spacing of 15 kHz, whereas various subcarrier spacings have been used in NR-U. Therefore, flexible SRS scheduling is required in NR-U. In other words, since CPE has not been used for SRS transmission in LTE LAA, SRS scheduling has been possible only at a symbol boundary. However, in NR-U, for more flexible SRS scheduling, an indication of CPE corresponding to an LBT type is also required along with the LBT type.

Therefore, in NR-U, it may be necessary to indicate an LBT type, CPE, and a CAPC as in a PUSCH even when not only the PUSCH but also a UL signal or channel such as the SRS or a PUCCH is transmitted.

Accordingly, the present disclosure provides a method of indicating the LBT type, the CPE, and/or the CAPC to transmit UL signals and channels of the UE in a U-band.

As described above, in NR-U, the PUCCH may be transmitted even in an unlicensed cell, and the CPE that may exist immediately before a position at which PUSCH transmission start is indicated may also be used for the SRS and the PUCCH.

Hereinafter, the PUSCH and the PUCCH will be collectively referred to as a PUXCH. In other words, the PUXCH may mean the PUSCH and/or the PUCCH.

A channel access parameter may mean a parameter included in DCI to indicate a channel access type (CAT) (or an LBT type), CPE, and/or a CAPC.

PUXCH and SRS transmissions may be simultaneously triggered through single UL DCI or single DL DCI. Specifically, an indication of PUSCH and SRS simultaneous transmissions may be triggered by a UL grant (i.e., UL DCI) that schedules UL. An indication of PUCCH and SRS simultaneous transmissions may be triggered by DL assignment (i.e., DL DCI) that schedules DL.

In this case, there is only one channel access parameter field indicating a state in which the CPE, the LBT type, and/or the CAPC is joint-encoded in the single UL DCI or the single DL DCI. That is, since a channel access parameter for each of the PUXCH and the SRS is not individually present, how to apply the indicated CPE, LBT type, and/or CAPC to the SRS and the PUXCH needs to be defined.

In other words, whether the value of a single channel access parameter field included in the single DCI is applied to both the PUXCH and the SRS or to only one of the PUXCH and the SRS may need to be defined.

Prior to a description of an example of the present disclosure, overall operation processes of a UE, a BS, and a network that implement examples of the present disclosure will now be described.

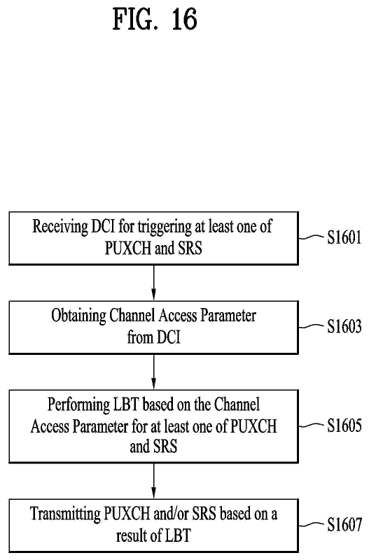

FIG. 16 is a diagram for explaining the overall operation process of the UE according to examples of the present disclosure.

Referring to FIG. 16, the UE may receive single DCI for triggering at least one of a PUXCH or an SRS (S1601). In this case, if the single DCI is UL DCI, at least one of a PUSCH or the SRS may be triggered through the UL DCI. If the single DCI is DL DCI, at least one of a PUCCH or the SRS may be triggered through the DL DCI.

The UE may obtain a channel access parameter from the single DCI (S1603). The channel access parameter may serve to indicate a CAP (or LBT type), CPE, and/or a CAPC. A method of applying the obtained channel access parameter to PUXCH and/or SRS transmission may be based on [Proposed Method #1], which will be described later.

The UE may perform LBT for PUXCH and/or SRS transmission using the obtained channel access parameters according to [Proposed Method #1] (S1605). In addition, when LBT is successful, the UE may transmit the PUSCH and/or the SRS according to a result of performing LBT (S1607).

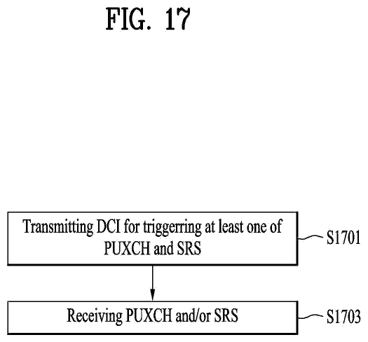

The overall operation process of the BS for implementing examples of the present disclosure will now be described based on FIG. 17.

Referring to FIG. 17, the BS may transmit single DCI for triggering at least one of a PUXCH or an SRS (S1701). In this case, if the single DCI is UL DCI, the BS may trigger at least one of a PUSCH or the SRS through the UL DCI. If the single DCI is DL DCI, the BS may trigger at least one of a PUCCH or the SRS through the DL DCI.

The BS may receive the PUXCH and/or the SRS transmitted based on a channel access parameter included in the corresponding DCI (S1703). The channel access parameter may serve to indicate a CAP (or LBT Type), CPE, and/or a CAPC. A method of applying the obtained channel access parameter to PUXCH and/or SRS transmission may be based on [Proposed Method #1], which will be described later.

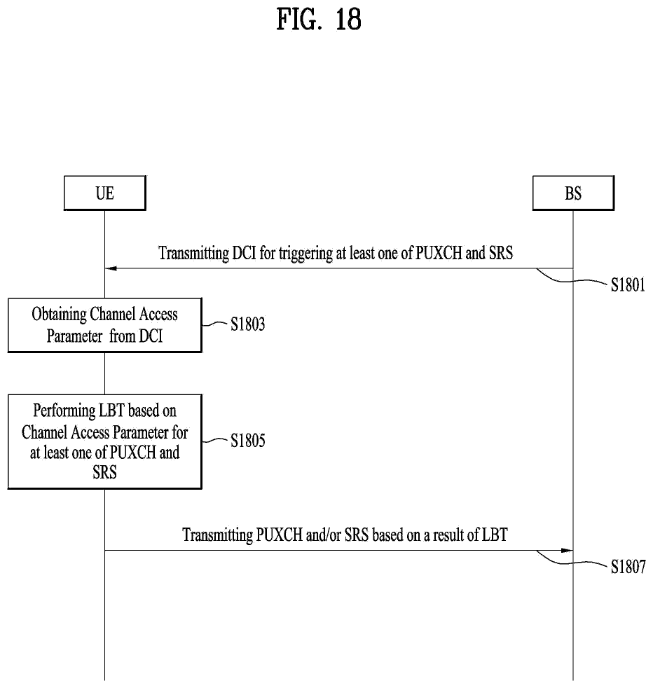

FIG. 18 is a diagram for explaining the overall operation process of the network for implementing examples of the present disclosure.

Referring to FIG. 18, the BS may transmit single DCI for triggering at least one of a PUXCH or an SRS to the UE (S1801). In this case, if the single DCI is UL DCI, the BS may trigger at least one of a PUSCH and the SRS through the UL DCI. If the single DCI is DL DCI, the BS may trigger at least one of a PUCCH or the SRS through the DL DCI.

The UE may obtain a channel access parameter from the single DCI (S1803). The channel access parameter may serve to indicate a CAP (or LBT type), CPE, and/or a CAPC. A method of applying the obtained channel access parameter to PUXCH and/or SRS transmission may be based on [Proposed Method #1], which will be described later.

The UE may perform LBT for PUXCH and/or SRS transmission using the obtained channel access parameter according to [Proposed Method #1] (S1805). Upon succeeding in performing LBT, the UE may transmit the PUSCH and/or the SRS to the BS as a result of performing LBT (S1807).

[Proposed Method #1]

A method of indicating the CAT/CPE/CAPC through the channel access parameter field, when at least one of the PUCCH or the SRS is triggered through single DL transmission scheduling DCI for the UE or at least one of the SRS or the PUSCH is triggered through single UL transmission scheduling DCI for the UE, will be described.

### 1. Embodiment #1-1

A channel access parameter entry set in which all or part of the CAT/CPE/CAPC for the PUXCH are joint-encoded as one entry and a channel access parameter entry set in which all or part of the CAT/CPE/CAPC for the SRS are joint-encoded as one entry may be individually configured for the UE through a higher-layer signal such as an RRC signal. In addition, one channel access parameter entry for the PUXCH and one channel access parameter entry for the SRS among the above-described two channel access parameter entry sets may be indicated through a physical layer signal such as DCI. That is, a single pair of entries may be indicated. In other words, if a channel access parameter included in the physical layer signal such as the DCI indicates one index, a channel access parameter entry for the PUXCH corresponding to the corresponding index and a channel access parameter entry for the SRS corresponding to the corresponding index may be used for the PUXCH and the SRS, respectively.

### 2. Embodiment #1-2

A channel access parameter entry set in which all or part of the CAT/CPE/CAPC for the PUXCH are joint-encoded as one entry and an entry set in which one or two of the CAT/CPE/CAPC for the SRS are joint-encoded as one entry may be individually configured for the UE through the higher-layer signal such as the RRC signal. In addition, one channel access parameter entry for the PUXCH and one channel access parameter entry for the SRS among the above-described two channel access parameter entry sets may be indicated through the physical layer signal such as the DCI. In this case, the CAT/CPE/CAPC that are not joint-encoded in the channel access parameter entry set configured for the SRS may be used for the CAT/CPE/CAPC for the PUXCH. For example, if the channel access parameter included in the physical layer signal such as the DCI indicates one index, a channel access parameter entry for the PUXCH corresponding to the index and a channel access parameter for the SRS corresponding to the index may be used to transmit the PUXCH and the SRS, respectively. If the CAT is not joint-encoded in the channel access parameter for the SRS, the CAT of the channel access parameter entry for the PUXCH corresponding to the corresponding index may be equally used for SRS transmission.

In Embodiment #1-1 and Embodiment #1-2 described above, even though one channel access parameter entry for the PUXCH and one channel access parameter entry for the SRS are indicated through the physical layer signal such as the DCI, the UE may selectively apply only specific information (e.g., CPE) in the channel access parameter entry set for the SRS.

### 3. Embodiment #1-3

If the SRS precedes the PUXCH in a scheduled timing order or the DL transmission scheduling DCI or the UL transmission scheduling DCI indicating SRS-only transmission is received, the CAT/CPE/CAPC for the PUXCH indicated by the DCI may also be applied to SRS transmission.

For example, the channel access parameter entry set in which all or part of the CAT/CPE/CAPC for the PUXCH are joint-encoded as one entry may be configured for the UE through the higher layer signal such as the RRC signal. If the DL transmission scheduling DCI or the UL transmission scheduling DCI indicates one entry in the channel access parameter entry set for the PUXCH, and if the DCI triggers only the SRS without triggering the PUXCH or triggers the SRS such that the SRS is transmitted first before the PUXCH, the indicated channel access parameter entry may be used for SRS transmission.

In this case, SRS and PUXCH transmission timings may be discontinuous or may be continuous.

### 4. Embodiment #1-4

When PUXCH and SRS transmissions are simultaneously triggered, the CAT/CPE/CAPC indicated by the DL transmission scheduling DCI or the UL transmission scheduling DCI may be applied only to the PUXCH (without being applied to the SRS) and, only when the SRS alone is triggered, the indicated CAT/CPE/CAPC may be applied to the SRS.

For example, the channel access parameter entry set in which all or part of the CAT/CPE/CAPC for the PUXCH is joint-encoded as one entry may be configured for the UE through the higher layer signal such as the RRC signal. If the DL transmission scheduling DCI or the UL transmission scheduling DCI indicates one channel access parameter entry in the channel access parameter entry set, the corresponding channel access parameter entry may be used for PUXCH transmission and may not be used for SRS transmission, when the corresponding DCI triggers both the PUXCH and the SRS. In contrast, if the PUXCH is not triggered and only the SRS is triggered, the corresponding channel access parameter entry may be used for SRS transmission.

In Embodiment #1-3 and Embodiment #1-4 described above, the DCI indicating SRS-only transmission may mean DL transmission scheduling DCI in which a non-numerical (or inapplicable) K1 value is indicated as a PUCCH transmission timing. For example, a K1 value, which is a HARQ-ACK feedback timing value corresponding to the PDSCH, may be indicated by DCI as any one of 1 to 8 values. However, if the K1 value is indicated by the DCI as a value (e.g., 0, 9, and 10) which does not correspond to the values of 1 to 8, this is a non-numerical (or inapplicable) value representing that SRS-only transmission is indicated without PUCCH scheduling.

Alternatively, the DCI indicating SRS-only transmission may mean UL transmission scheduling DCI in which CSI-RS-only transmission is triggered without PUSCH scheduling.

In the above proposed method, SRS transmission indicated by single DL or UL DCI may mean both single SRS transmission and two or more multiple SRS transmissions. That is, SRS-only transmission may include both the case in which a single SRS is transmitted and the case in which a plurality of SRSs is transmitted. In other words, SRS-only transmission may mean the case in which SRS transmission is triggered without PUXCH scheduling regardless of the number of triggered SRSs. In the case in which SRS-only transmission means a plurality of SRS transmissions, an SRS to which the proposed method will be applied among a plurality of SRSs may be determined according to a previous appointment/configuration/instruction. For example, according to the appointment/configuration/instruction, the proposed method may be applied only to preceding SRS transmission (in the earliest position in temporal order), may be applied only to all SRS transmissions, or may be applied only to following SRS transmission (in the latest position in temporal order).

The above proposed methods will now be described in more detail.

The CAT/CPE/CAPC may need to be indicated not only for PUSCH transmission but also for PUCCH and SRS transmissions. In particular, when PUSCH and SRS transmissions or PUCCH and SRS transmissions are simultaneously triggered through single DL transmission scheduling DCI or single UL transmission scheduling DCI, since the channel access parameter indication field in the DCI is not separately configured to distinguish between the PUXCH (the PUCCH or the PUSCH) and the SRS, a method of applying the indicated CAT/CPE/CAPC to the PUXCH and the SRS may be required.

In Embodiment #1-1, the channel access parameter entry set in which all or part of the CAT/CPE/CAPC for the PUXCH are joint-encoded and the channel access parameter entry set in which all or part of the CAT/CPE/CAPC for the SRS are joint-encoded may be individually configured through the higher-layer signal such as the RRC signal.

If a specific index is indicated through the channel access parameter field of the DCI, Embodiment #1-1 is a method of indicating a pair of one channel access parameter entry for the PUXCH corresponding to the index and one channel access parameter entry for the SRS corresponding to the index. For example, channel access parameter entry index 0 for the PUSCH indicates CAT=Type 2C and CPE=0, and channel access parameter entry index 0 for the SRS indicates CAT=Type 2B and CPE=1. In this case, if the channel access parameter field of the DCI indicates index 0, the CAT and CPE corresponding to each configured channel access parameter entry index 0 may be applied to the SRS and the PUSCH. In other words, if the channel access parameter field indicates index 0 through the DCI, the SRS may be transmitted based on CAT=Type 2B and CPE=1, and the PUSCH may be transmitted based on CAT=Type 2C and CPE=0.

In Embodiment #1-2, although the channel access parameter entry set for the PUXCH and the channel access parameter entry set for the SRS are individually configured through RRC as in Embodiment #1-1, one or two of the CAT/CPE/CAPC may be joint-encoded as one entry for the channel access parameter entry set for the SRS.

If the channel access parameter field of the DCI indicates a specific index, parameters of the channel access parameter entry configured for the PUXCH may be applied to parameters not included in the channel access parameter entry set for the SRS among the CAT/CPE/CAPC. For example, assume that channel access parameter entry index 0 for the PUSCH indicates CAT=Type 2C and CPE=0, and channel access parameter entry index 0 for the SRS indicates CPE=1. If the channel access parameter field of the DCI indicates index 0, the SRS may be transmitted based on CPE=1 corresponding to channel access parameter entry index 0 for the SRS and on CAT=Type 2C corresponding to channel access parameter entry index 0 for the PUSCH.

Embodiment #1-3 is a method of applying the channel access parameter indicated by the DCI to SRS transmission according to the scheduled timing order of the SRS and the PUXCH. When the SRS is scheduled ahead of the PUXCH in temporal order, when a non-numerical (or inapplicable) K1 value is indicated as a PUCCH transmission timing through the DL transmission scheduling DCI, or when only CSI-RS transmission is triggered without PUSCH scheduling through the UL transmission scheduling DCI so that the SRS alone is transmitted, the channel access parameter (e.g., CAT/CPE/CAPC) for the PUXCH indicated by the UL DCI or the DL DCI may also be applied to SRS transmission.

In embodiment #1-4, when PUXCH and SRS transmissions are simultaneously triggered, the channel access parameter (e.g., CAT/CPE/CAPC) indicated by the DL transmission scheduling DCI or the UL transmission scheduling DCI may be applied only to the PUXCH (without being applied to the SRS) and, only when the SRS alone is triggered, the indicated channel access parameter (e.g., CAT/CPE/CAPC) may be applied to the SRS. That is, in the case of SRS+PUSCH or SRS+PUCCH, the channel access parameter (e.g., CAT/CPE/CAPC) may be applied only to the PUSCH or the PUCCH and, in the case of SRS-only transmission, the channel access parameter (e.g., CAT/CPE/CAPC) may be applied to the SRS.

Since examples of the above-described proposed methods may be included in one of implementation methods of the present disclosure, it is obvious that the examples may be regarded as proposed methods. Although the above-described proposed methods may be independently implemented, the proposed methods may be implemented in a combined (added) form of parts of the proposed methods. For example, although one example of Embodiment #1-1 to Embodiment #1-4 of Proposed Method #1 may be independently implemented, two or more examples thereof may be implemented in combination.

A rule may be defined such that information as to whether the proposed methods are applied (or information about rules of the proposed methods) is indicated by the BS to the UE or by the transmission UE to the reception UE through a predefined signal (e.g., a physical layer signal or a higher-layer signal).

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

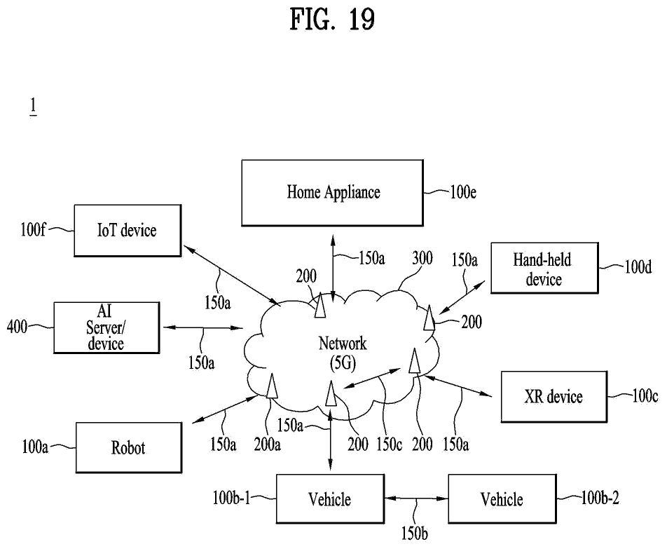

FIG. 19 illustrates a communication system 1 applied to the present disclosure.

Referring to FIG. 19, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HIVID), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul(IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

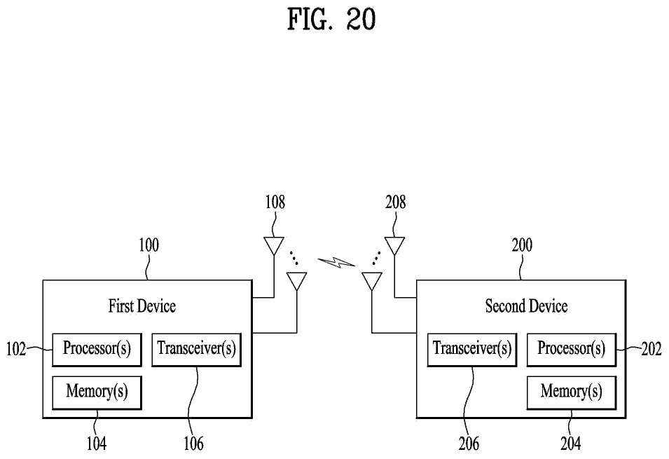

FIG. 20 illustrates wireless devices applicable to the present disclosure.

Referring to FIG. 20, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 19.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor 102 of the first wireless device 100 and stored in the memory 104 of the first wireless device 100, according to an embodiment of the present disclosure will be described.

Although the following operations will be described based on a control operation of the processor 102 in terms of the processor 102, software code for performing such an operation may be stored in the memory 104. For example, in the present disclosure, the at least one memory 104 may store instructions or programs as a computer-readable storage medium. The instructions or programs may cause, when executed, the at least one processor operably connected to the at least one memory to perform operations according to embodiments or implementations of the present disclosure, related to the following operations.

Specifically, the processor 102 may control the transceiver 106 to receive single DCI for triggering at least one of a PUXCH or an SRS. In this case, if the single DCI is UL DCI, at least one of a PUSCH or the SRS may be triggered through the UL DCI. If the single DCI is DL DCI, at least one of a PUCCH or the SRS may be triggered through the DL DCI.

The processor 102 may obtain a channel access parameter from the single DCI. The channel access parameter may serve to a CAP (or LBT type), CPE, and/or a CAPC. A method of applying the obtained channel access parameter to PUXCH and/or SRS transmission may be based on [Proposed Method #1],

The processor 102 may perform LBT for PUXCH and/or SRS transmission using the obtained channel access parameters according to [Proposed Method #1]. In addition, when LBT is successful, the processor 102 may control the transceiver 106 to transmit the PUSCH and/or the SRS according to a result of performing LBT.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor 202 of the second wireless device 200 and stored in the memory 204 of the second wireless device 200, according to an embodiment of the present disclosure will be described.

Although the following operations will be described based on a control operation of the processor 202 in terms of the processor 202, software code for performing such an operation may be stored in the memory 204. For example, in the present disclosure, the at least one memory 204 may store instructions or programs as a computer-readable storage medium. The instructions or programs may cause, when executed, the at least one processor operably connected to the at least one memory to perform operations according to embodiments or implementations of the present disclosure, related to the following operations.

Specifically, the processor 202 may control the transceiver 206 to transmit single DCI for triggering at least one of a PUXCH or an SRS. In this case, if the single DCI is UL DCI, at least one of a PUSCH or the SRS may be triggered through the UL DCI. If the single DCI is DL DCI, at least one of a PUCCH or the SRS may be triggered through the DL DCI.

The processor 202 may control the transceiver 206 to receive the PUXCH and/or the SRS transmitted based on a channel access parameter included in corresponding DCI. The channel access parameter may serve to a CAP (or LBT type), CPE, and/or a CAPC. A method of applying the obtained channel access parameter to PUXCH and/or SRS transmission may be based on [Proposed Method #1],

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

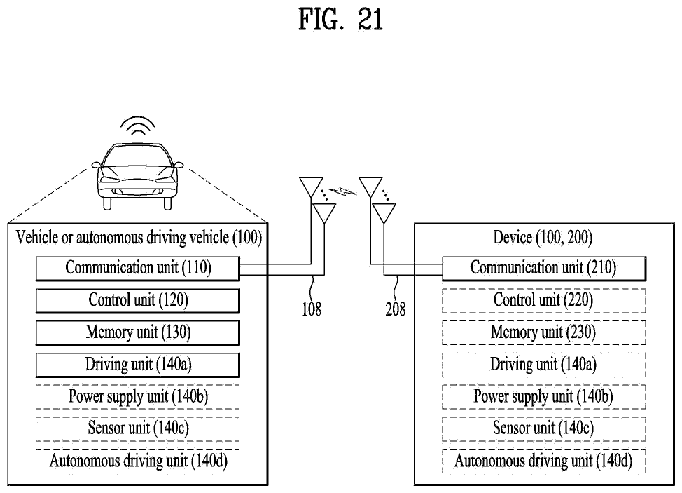

FIG. 21 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 21, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

While the above-described method of transmitting and receiving an SRS and the apparatus therefor have been described based on an example applied to a 5G NR system, the method and apparatus are applicable to various wireless communication systems in addition to the 5G NR system.

1. A method of transmitting a sounding reference signal (SRS) by a user equipment (UE) in a wireless communication system, the method comprising:
receiving downlink control information (DCI) for scheduling an uplink channel and the SRS;
obtaining a channel access parameter included in the DCI; and
transmitting, based on the DCI scheduling the SRS without scheduling the uplink channel, the SRS based on the channel access parameter.

2. The method of claim 1, wherein the uplink channel is a physical uplink control channel (PUCCH) based on the DCI being downlink scheduling DCI.

3. The method of claim 1, wherein the uplink channel is a physical uplink shared channel (PUSCH) based on the DCI being uplink scheduling DCI.

4. The method of claim 1, wherein the channel access parameter is for informing information related to at least one of a channel access type (CAT), cyclic prefix extension (CPE), or a channel access priority class (CAPC).

5. The method of claim 1, wherein the DCI includes an invalid physical uplink control channel (PUCCH) transmission timing value.

6. The method of claim 1, wherein the DCI is for trigger a channel state information reference signal (CSI-RS).

7. A user equipment (UE) for transmitting a sounding reference signal (SRS) in a wireless communication system, the UE comprising:
at least one transceiver;
at least one processor; and
at least one computer memory operably connected to the at least one processor and configured to store instructions that, when executed, cause the at least one processor to perform operations comprising:
receiving downlink control information (DCI) for scheduling an uplink channel and the SRS through the at least one transceiver;
obtaining a channel access parameter included in the DCI; and
transmitting, based on the DCI scheduling the SRS without scheduling the uplink channel, the SRS based on the channel access parameter through the at least one transceiver.

8. The UE of claim 7, wherein the uplink channel is a physical uplink control channel (PUCCH) based on the DCI being downlink scheduling DCI.

9. The UE of claim 7, wherein the uplink channel is a physical uplink shared channel (PUSCH) based on the DCI being uplink scheduling DCI.

10. The UE of claim 7, wherein the channel access parameter is for informing information related to at least one of a channel access type (CAT), cyclic prefix extension (CPE), or a channel access priority class (CAPC).

11. The UE of claim 7, wherein the DCI includes an invalid physical uplink control channel (PUCCH) transmission timing value.

12. The UE of claim 7, wherein the DCI is for trigger a channel state information reference signal (CSI-RS).

13. An apparatus for a user equipment (UE) for transmitting a sounding reference signal (SRS) in a wireless communication system, the apparatus comprising:
at least one processor; and
at least one computer memory operably connected to the at least one processor and configured to store instructions that, when executed, cause the at least one processor to perform operations comprising:
receiving downlink control information (DCI) for scheduling an uplink channel and the SRS;
obtaining a channel access parameter included in the DCI; and
transmitting, based on the DCI scheduling the SRS without scheduling the uplink channel, the SRS based on the channel access parameter.

14. A computer-readable storage medium including at least one computer program causing at least one processor to perform an operation, the operations comprising:
receiving downlink control information (DCI) for scheduling an uplink channel and a sounding reference signal (SRS);
obtaining a channel access parameter included in the DCI; and
transmitting, based on the DCI scheduling the SRS without scheduling the uplink channel, the SRS based on the channel access parameter.

15. A method of receiving a sounding reference signal (SRS) by a base station (BS) in a wireless communication system, the method comprising:
transmitting downlink control information (DCI) for scheduling an uplink channel and the SRS; and
receiving, based on the DCI scheduling the SRS without scheduling the uplink channel, the SRS based on a channel access parameter informed by the DCI.

16. A base station (BS) for receiving a sounding reference signal (SRS) in a wireless communication system, the BS comprising:
at least one transceiver;
at least one processor; and
at least one computer memory operably connected to the at least one processor and configured to store instructions that, when executed, cause the at least one processor to perform operations comprising:
transmitting downlink control information (DCI) for scheduling an uplink channel and the SRS through the at least one transceiver; and
receiving, based on the DCI scheduling the SRS without scheduling the uplink channel, the SRS based on a channel access parameter informed by the DCI through the at least one transceiver.
